(19) United States
(12) Patent Application Publication
(10) Pub. No.: US 2025/0256937 A1
(43) Pub. Date: Aug. 14, 2025

(54) SHEET FOLDING APPARATUS, IMAGE FORMING APPARATUS, AND IMAGE FORMING SYSTEM

(71) Applicant: Takuya MORINAGA, Kanagawa (JP)

(72) Inventor: Takuya MORINAGA, Kanagawa (JP)

(73) Assignee: Ricoh Company, Ltd., Tokyo (JP)

(21) Appl. No.: 19/035,164

(22) Filed: Jan. 23, 2025

(30) Foreign Application Priority Data
Feb. 14, 2024 (JP) 2024-020514

(51) Int. Cl. B65H 37/06; B65H 43/00; G03G 15/00

(52) U.S. Cl. CPC B65H 37/06; B65H 43/00; G03G 15/6538; B65H 2301/45; B65H 2513/52; B65H 2515/30; B65H 2557/24; B65H 2557/63; B65H 2801/27; G03G 2215/00877

(57) ABSTRACT

A sheet folding apparatus includes a sheet folder and circuitry. The sheet folder includes a sheet folding part, and an additional folding part to reinforce a folding portion in the sheet. The circuitry is to control the sheet folder to form and reinforce the folding portion in the sheet; acquire, before completion of a folding operation, first sheet information of the sheet and first folding information indicating a type of the folding operation on the sheet; run a trained model obtained through machine learning executed using second sheet information of a training sheet, second folding information indicating a type of the folding operation on the training sheet, and multiple training datasets including a folding evaluation value; estimate the folding evaluation value after the completion of the folding operation on the sheet; and determine the type of a control content in the folding operation, based on the folding evaluation value.

### CROSS-REFERENCE TO RELATED APPLICATION

This patent application is based on and claims priority pursuant to 35 U.S.C. § 119 (a) to Japanese Patent Application No. 2024-020514, filed on Feb. 14, 2024, in the Japan Patent Office, the entire disclosure of which is hereby incorporated by reference herein.

### BACKGROUND

### Technical Field

Embodiments of the present disclosure relate to a sheet folding apparatus, an image forming apparatus, and an image forming system.

### Background Art

Typical sheet folding apparatuses include a sheet folding device that folds a processing target sheet, a folding processing device including a fold-enhancing portion that performs fold-enhancing on a crease (folded portion) formed in the process target sheet by the sheet folding portion, and a controller that controls a sheet folding operation performed by the folding processing device.

For example, a sheet folding apparatus is known that includes a fold-enhancing roller (fold-enhancing portion) that enhances (reinforce) a folded portion (fold) in a sheet folded by a sheet folding roller pair (sheet folding portion). In this sheet folding apparatus, the number of times of fold-enhancing operations is set according to the number of times of multi-folding operations of overlapped sheets (processing target sheets).

Since user's conditions for appropriately selecting the content of the sheet folding operation in a sheet folding apparatus (for example, the number of times of fold-enhancing operations) are different from each other and depend on each user, the number of combinations of the conditions is enormous, and it is difficult to appropriately select and execute the content of the sheet folding operation under the usage condition of each user.

### SUMMARY

Embodiments of the present disclosure described herein provide a novel sheet folding apparatus including a sheet folder and circuitry. The sheet folder includes a sheet folding part and an additional folding part. The sheet folding part folds a sheet to form a fold in the sheet. The additional folding part enforces the fold in the sheet folded by the sheet folding part. The circuitry is to control the sheet folder to form the fold and enforce the fold in the sheet, as a folding operation; acquire, before completion of the folding operation, first sheet information of the sheet to which the sheet folder performs the folding operation, and first folding information indicating a type of the folding operation to be performed on the sheet by the sheet folder; run a trained model obtained through machine learning executed using second sheet information of a training sheet, second folding information indicating a type of the folding operation performed on the training sheet, and multiple training datasets including a folding evaluation value obtained by performing the folding operation on the training sheet; estimate the folding evaluation value after the completion of the folding operation on the sheet, based on the first sheet information and the first folding information; and determine the type of a control content in the folding operation to be performed by the sheet folder on the sheet, based on the folding evaluation value.

Further, embodiments of the present disclosure described herein provide an image forming apparatus including the above-described sheet folding apparatus.

Further, embodiments of the present disclosure described herein provide an image forming system including an image forming apparatus to form an image on a sheet, and the above-described sheet folding apparatus to perform the folding operation on the sheet, on which the image is formed by the image forming apparatus, as the processing target sheet.

Further, embodiments of the present disclosure described herein provide a sheet folding apparatus including a sheet folder and circuitry. The sheet folder includes a sheet folding part and an additional folding part. The sheet folding part folds a sheet. The additional folding part enhances a fold in the sheet formed by the sheet folding part. The circuitry is to control the sheet folder to form the fold and enforce the fold in the sheet, as a folding operation; acquire, before completion of the folding operation, first sheet information of the sheet on which the sheet folder performs the folding operation, and first driving state information of a driving state of the sheet folder during the folding operation; run a trained model obtained through machine learning executed using second sheet information of a training sheet, second driving state information of a driving state of the sheet folder during the folding operation on the training sheet, and multiple training datasets including a folding evaluation value after the folding operation on the training sheet; estimate the folding evaluation value after the folding operation on the sheet, based on the first sheet information and the first driving state information; and determine the type of a control content in the folding operation to be performed by the sheet folder on the sheet, based on the folding evaluation value.

Further, embodiments of the present disclosure described herein provide an image forming apparatus including the above-described sheet folding apparatus.

Further, embodiments of the present disclosure described herein provide an image forming system including an image forming apparatus to form an image on a sheet, and the above-described sheet folding apparatus to perform the folding operation on the sheet, on which the image is formed by the image forming apparatus, as the processing target sheet.

### BRIEF DESCRIPTION OF THE SEVERAL VIEWS OF THE DRAWINGS

Exemplary embodiments of this disclosure will be described in detail based on the following figures, wherein:

FIG. 1 is a schematic diagram illustrating an overall configuration of an image forming system including a sheet folding sheet folding apparatus according to an embodiment of the present disclosure;

FIG. 2 is a diagram illustrating a schematic configuration of conveyance paths of the sheet folding apparatus of FIG. 1;

FIGS. 3A, 3B, 3C and 3D are operation diagrams illustrating details of a sheet overlaying operation in the sheet folding apparatus of FIG. 1;

FIGS. 4A, 4B, 4C and 4D are operation diagrams illustrating details of a Z-fold operation as one of folding patterns in the sheet folding apparatus of FIG. 1;

FIG. 5 is a block diagram illustrating a control circuit of the sheet folding apparatus of FIG. 1;

FIG. 6 is a front view of a fold-enhancing roller included in the sheet folding apparatus of FIG. 1;

FIG. 7 is a side view of the fold-enhancing roller of FIG. 6;

FIG. 8 including FIGS. 8 (a) and 8 (b) is a diagram illustrating a fold-enhancing operation by the fold-enhancing roller of FIG. 6;

FIGS. 9A, 9B, 9C, 9D and 9E are operation diagrams illustrating details of a fold-enhancing operation in the sheet folding apparatus of FIG. 1;

FIG. 10 is a diagram illustrating a training phase of a trained model executed by a central processing unit (CPU) of a control circuit in the sheet folding apparatus of FIG. 1;

FIG. 11 is a diagram illustrating a table of an example of labeled training datasets used as training datasets for the trained model of FIG. 10;

FIGS. 12A, 12B and 12C are diagrams illustrating positions and movements of a sheet in the Z-folding operation and time changes (current waveforms) in a drive current value of a sheet folder motor;

FIG. 13 is a graph illustrating an influence on the height of fold of a sheet or sheets at a fold-enhancing stop position depending on a difference in environmental information including temperature and humidity;

FIG. 14 is a diagram illustrating a sheet folding apparatus according to Modification 1;

FIG. 15 is a block diagram illustrating a control circuit of the sheet folding apparatus of FIG. 14;

FIG. 16 is a flowchart of a control related to an adjustment of time between sheets in a sheet folding apparatus according to Modification 2;

FIG. 17 is a table of an example of reference values of the height of fold of a sheet or sheets for determining whether or not a fold-enhancing control parameter is to be changed in Modification 2;

FIGS. 18A, 18B and 18C are diagrams illustrating an adjustment of time between sheets in a sheet folding apparatus according to Modification 3;

FIG. 19 is a diagram illustrating an example of a press-type configuration as another example of a fold-enhancing-type configuration;

FIG. 20 is a diagram illustrating an example of a roller-pressure-type configuration as yet another example of a fold-enhancing-type configuration;

FIG. 21 is a table of kinds of a fold-enhancing-type configuration and a fold-enhancing control parameter adjustable by various configurations; and

FIG. 22 is a diagram illustrating an example of a configuration in which a trained model is included in a device other than a sheet folding apparatus.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Descriptions are given of embodiments of an image forming system using a sheet folding apparatus according to the present disclosure as a post-processing apparatus of an image forming apparatus, with reference to the accompanying drawings.

The sheet folding apparatus according to the present disclosure is an example of a post-processing apparatus that performs a sheet folding operation on a sheet, on which an image is formed by an image forming apparatus, as a processing target sheet.

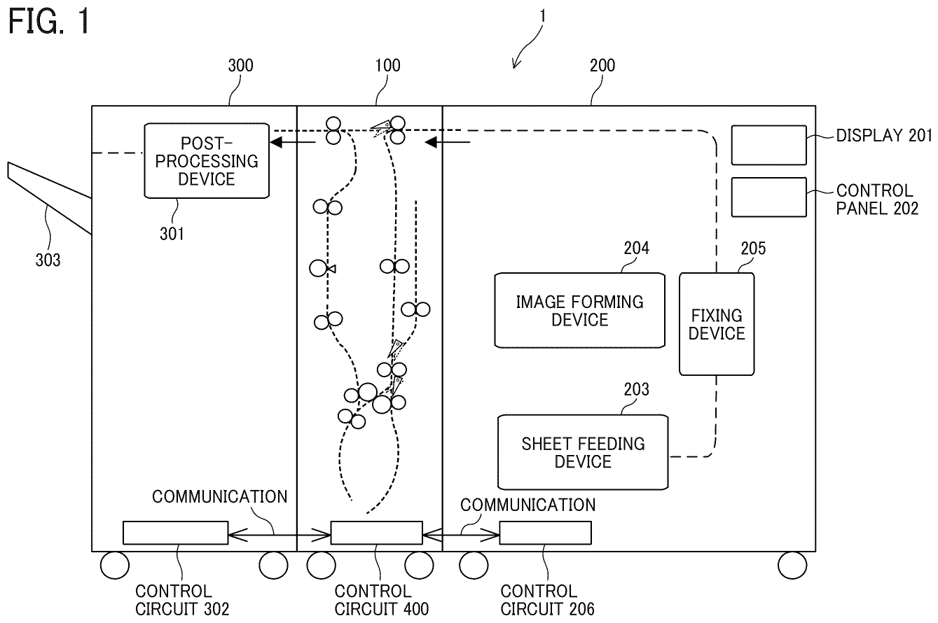

FIG. 1 is a schematic diagram illustrating an overall configuration of an image forming system including a sheet folding apparatus according to an embodiment of the present disclosure.

An image forming system 1 according to the present embodiment includes an image forming apparatus 200, a sheet folding apparatus 100, and a finisher 300. In the image forming system 1, the sheet folding apparatus 100 is disposed downstream from the image forming apparatus 200 in a sheet conveyance direction and is coupled to the image forming apparatus 200, and the finisher 300 is disposed downstream from the sheet folding apparatus 100 in the sheet conveyance direction and is coupled to the sheet folding apparatus 100. The sheet folding apparatus 100 receives a sheet on which an image is formed by the image forming apparatus 200, and executes a given sheet folding operation on the sheet. The finisher 300 receives a sheet or a sheet bundle conveyed out from the sheet folding apparatus 100, and performs a post-processing operation by a post-processing device 301 that performs, for example, a stapling operation. The sheet or the sheet bundle conveyed out from the finisher 300 is placed on a sheet stacking tray 303.

The image forming apparatus 200 is an apparatus that forms an image on a sheet by a known electrophotographic process. The image forming apparatus 200 according to the present embodiment includes a display 201, a control panel 202, a sheet feeding device 203, an image forming device 204, a fixing device 205, and a control circuit 206.

The display 201 displays screens for notifying a user of states of various devices and operation contents. The control panel 202 is a user interface for the user to, for example, perform various operations such as a setting of an operation mode and the number of copies to be printed. The sheet feeding device 203 accommodates multiple sheets to be separated and fed one by one. The image forming device 204 forms a latent image on a surface of a photoconductor as a latent image bearer according to image data input to the image forming device 204. Then, the image forming device 204 develops the latent image into a toner image (image), and transfers the thus-obtained toner image onto a sheet fed from the sheet feeding device 203. The fixing device 205 fixes the toner image transferred by the image forming device 204 onto the surface of the sheet, to the sheet. The control circuit 206 controls the operations of the units included in the image forming apparatus 200.

The image forming method applicable to the image forming apparatus 200 may be not only to electrophotography but also to any known image forming methods such as inkjet and thermal transfer.

The sheet folding apparatus 100 and the finisher 300 are also provided with control circuits 302 and 400, respectively. The control circuits 302 and 400 communicate with the control circuit 206 of the image forming apparatus 200 to control the respective units of the sheet folding apparatus 100 and the finisher 300.

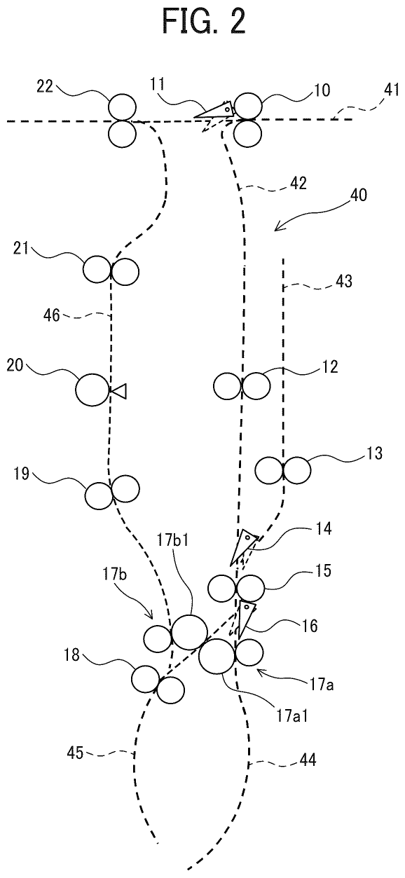

FIG. 2 is a diagram illustrating a schematic configuration of conveyance paths 40 of the sheet folding apparatus 100 of FIG. 1.

In FIG. 2, the conveyance paths 40 are indicated with broken lines.

In FIG. 2, the conveyance paths 40 includes six paths, which are a first path 41, a second path 42, a third path 43, a fourth path 44, a fifth path 45 and a sixth path 46.

The first path 41 is a path for linearly conveying a sheet from the image forming apparatus 200 to the finisher 300.

The second path 42 is a path that branches downward from a first branching claw 11 on the first path 41 in a sheet conveyance direction, and reaches a third branching claw 16.

The third path 43 is a path that branches upward from a second branching claw 14 upstream from the third branching claw 16 on the second path 42 in the sheet conveyance direction.

The fourth path 44 is a path extending downstream from the third branching claw 16 in the sheet conveyance direction via a first folding roller pair 17a.

The fifth path 45 is a path extending downward from the third branching claw 16 that is extreme downstream of the second path 42 in the sheet conveyance direction, via a nip region formed by a roller 17al of the first folding roller pair 17a and a roller 17b1 of a second folding roller pair 17b.

The sixth path 46 is a path that branches upward from the fifth path 45 and joins the first path 41.

The branch point from the sixth path 46 to the fifth path 45 is disposed between a third conveyance roller pair 18 and each of the first folding roller pair 17a and the second folding roller pair 17b. The meeting point from the sixth path 46 to the first path 41 is at a position immediately before the nip region upstream from the sixth conveyance roller pair 22 in the sheet conveyance direction.

In the conveyance paths 40 described above, a sheet that is conveyed to the second path 42 branched from the first path 41 on the downstream side of a first conveyance roller pair 10 in the sheet conveyance direction is appropriately conveyed through the third path 43, the fourth path 44 and the fifth path 45, according to the folding pattern by the sheet folding operation. Subsequently, the sheet is returned to the first path 41 through the sixth path 46, and is then conveyed to the finisher 300.

In the first path 41, the first conveyance roller pair 10 is upstream from the branch point of the second path 42 in the sheet conveyance direction, and the sixth conveyance roller pair 22 is downstream from the meeting point of the sixth path 46 in the sheet conveyance direction. A registration roller pair 15 is immediately before a position extreme downstream from the second path 42 in the sheet conveyance direction and upstream from the third branching claw 16 in the sheet conveyance direction. The second branching claw 14 is upstream from the registration roller pair 15 in the sheet conveyance direction. A second conveyance roller pair 12 is at a position upstream from the second branching claw 14 of the second path 42 in the sheet conveyance direction and in the middle from the branch point of the first path 41. Further, a multi-sheet-folding roller pair 13 is downstream from the second branching claw 14 of the third path 43 in the sheet conveyance direction.

The first folding roller pair 17a is immediately after at a position downstream from the third branching claw 16 of the fourth path 44 in the sheet conveyance direction. A conveyance roller pair including the roller 17al of the first folding roller pair 17a and the roller 17b1 of the second folding roller pair 17b is immediately after a position downstream from the third branching claw 16 of the fifth path 45 in the sheet conveyance direction. Further, the third conveyance roller pair 18 is downstream from the conveyance roller pair including the roller 17al of the first folding roller pair 17a and the roller 17b1 of the second folding roller pair 17b of the fifth path 45 in the sheet conveyance direction. The sixth path 46 is branched from a position between the conveyance roller pair including the roller 17al of the first folding roller pair 17a and the roller 17b1 of the second folding roller pair 17b in the sheet conveyance direction and the third conveyance roller pair 18.

The second folding roller pair 17b is immediately after a position upstream from the branch point on the sixth path 46 from the fifth path 45 in the sheet conveyance direction. A fourth conveyance roller pair 19 and a fifth conveyance roller pair 21 are aligned in the sheet conveyance direction, at positions downstream from the sixth path 46. A fold-enhancing roller 20 is between the fourth conveyance roller pair 19 and the fifth conveyance roller pair 21. The sheet conveyance direction in this specification is described based on a direction in which a sheet is conveyed from the image forming apparatus 200 to the finisher 300.

As illustrated in FIG. 2, the sheet folding apparatus 100 receives the sheet from the image forming apparatus 200 and further conveys the sheet by the first conveyance roller pair 10 toward downstream in the sheet conveyance direction. By driving the first branching claw 11, the sheet is conveyed to the second path 42 at the lower side in the drawing when the sheet folding operation is performed, and the sheet is conveyed to the left side in the drawing along the first path 41 when the sheet folding operation is not performed. The sheet folding operation is performed by using three nip regions formed by the first folding roller pair 17a and the second folding roller pair 17b, as sheet folding portions.

The sheet that is folded by the first folding roller pair 17a and the second folding roller pair 17b is conveyed upward in the drawing along the sixth path 46, and is pressed by the fold-enhancing roller 20 as a fold-enhancing portion, so that the crease in the sheet is reinforced (enhanced). After the above-described operation, the sheet is conveyed by the fifth conveyance roller pair 21 and the sixth conveyance roller pair 22 to be conveyed to the finisher 300. When multi-sheet folding in which multiple sheets overlaid on one after another are folded together, the sheet overlaying operation is performed by using the multi-sheet-folding roller pair 13 and sheet conveyance roller pairs near the sheet overlaying operation, before the sheet folding operation.

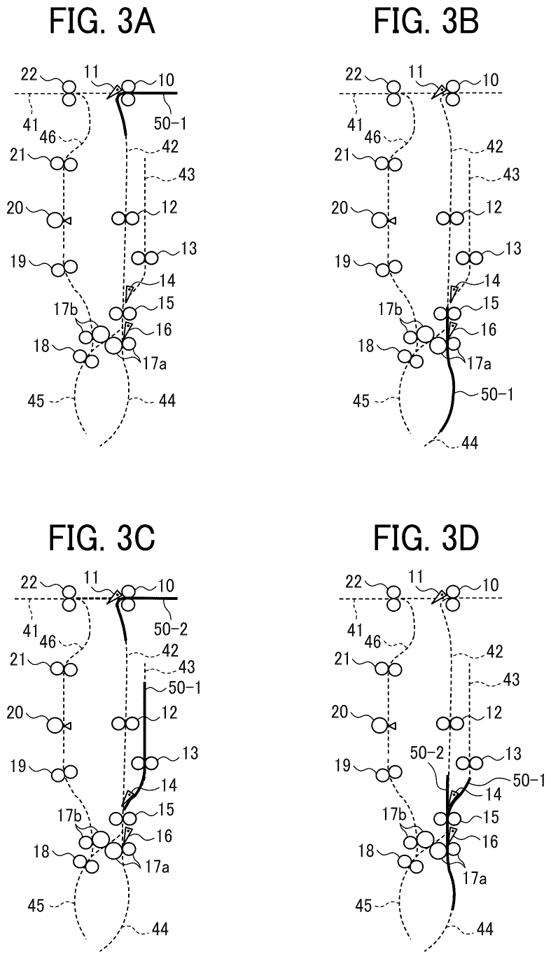

FIGS. 3A, 3B, 3C and 3D are operation diagrams illustrating details of the sheet overlaying operation in the sheet folding apparatus 100.

As illustrated in FIG. 3A, a first sheet 50-1 conveyed from the image forming apparatus 200 along the first path 41 is conveyed by the first conveyance roller pair 10 and the first branching claw 11 toward the second path 42. Subsequently, as illustrated in FIG. 3B, the first sheet 50-1 is guided from the second path 42 to the fourth path 44 by the third branching claw 16. When the trailing end of the first sheet 50-1 passes the second branching claw 14, the position of the second branching claw 14 is changed. Then, as illustrated in FIG. 3C, the first sheet 50-1 is switched back by reversing a rotational direction of the second conveyance roller pair 12 and the first folding roller pair 17a.

The first sheet 50-1 that is switched back is conveyed by the multi-sheet-folding roller pair 13 along the third path 43, and is retracted to a position at which the first sheet 50-1 is fully passed through the registration roller pair 15. With the first sheet 50-1 being fully passed through the registration roller pair 15, a second sheet 50-2 is received in the second path 42. Subsequently, as illustrated in FIG. 3D, at the timing when the leading end of the second sheet 50-2 in the sheet conveyance direction reaches the registration roller pair 15, the first sheet 50-1 is conveyed toward the fourth path 44 (downward in FIG. 3D), and the first sheet 50-1 and the second sheet 50-2 are conveyed while being overlaid each other. At this time, based on the detection timing of a leading end detection sensor disposed immediately before the second branching claw 14 on the second path 42, the drive start timing of the multi-sheet-folding roller pair 13 is set, so that the leading ends of two sheets, which are the first sheet 50-1 and the second sheet 50-2, are matched and are conveyed to the fourth path 44. Due to this sheet overlaying operation, the two sheets, which are the first sheet 50-1 and the second sheet 50-2, are conveyed as one sheet bundle 51.

When three or more sheets are overlaid, the sheet bundle 51 including two overlaid sheets is switched back again at the timing at which the trailing end of the sheet bundle 51 is passed through the second branching claw 14, and is retracted to the third path 43. By repeating the above-described operation according to the number of sheets to be overlaid, the sheet overlaying operation for a desired number of sheets can be performed.

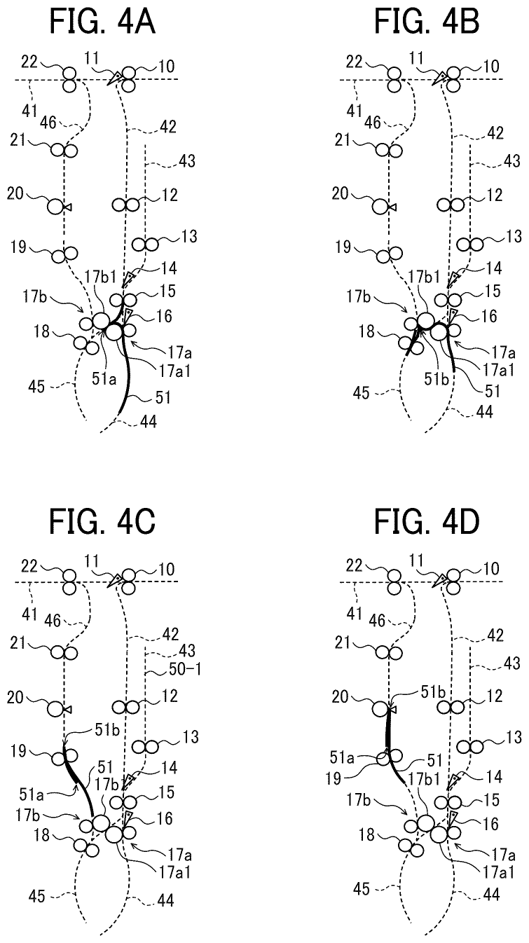

FIGS. 4A, 4B, 4C and 4D are operation diagrams illustrating details of a Z-fold operation as one of folding patterns in the sheet folding apparatus of FIG. 1.

Although the sheet folding operation that is performed on the sheet bundle 51 (including the first sheet 50-1 and the second sheet 50-2) subjected to the sheet overlaying operation will be described as an example, the sheet folding operation that is performed on a single sheet 50 is the same as the sheet folding operation for the sheet bundle 51, except that the switchback is performed using the third path 43 described below.

As the sheet bundle 51 subjected to the sheet overlaying operation is conveyed in the sheet conveyance direction, the rotation of the first folding roller pair 17a alone is reversed at the timing at which the crease of the Z-fold is formed at a position of the sheet bundle 51 by one-fourth (¼) downstream in the sheet conveyance direction, and an upstream portion of the sheet bundle 51 in the sheet conveyance direction is conveyed from the fourth path 44 to the fifth path 45. At this time, the registration roller pair 15 also conveys the downstream portion of the sheet bundle 51 in the sheet conveyance direction toward the fifth path 45. For this reason, the sheet bundle 51 receives the conveyance force of both the first folding roller pair 17a and the registration roller pair 15. As a result, the sheet bundle 51 is warped at the upstream portion in the nip region of the rollers 17al and 17b1 in the sheet conveyance direction in the fifth path 45. When the sheet bundle 51 is further conveyed with being warped on the upstream side of the nip region of the roller pair, the warped portion of the sheet bundle 51 is pushed to enter the nip region of the rollers 17al and 17b1. Then, a first fold 51a is formed at the position by one-fourth (¼) from the leading end of the sheet bundle 51 in the nip region of the roller pair including the rollers 17a1 and 17b1.

The sheet bundle 51 with the first fold 51a is further conveyed downstream from the roller pair including the rollers 17a1 and 17b1 in the sheet conveyance direction in the fifth path 45. Then, the rotation of the third conveyance roller pair 18 on the fifth path 45 is reversed so that a second fold 51b is formed at the position by one-half (½) from the leading end of the sheet bundle 51 in the sheet conveyance direction. As a result, as illustrated in FIG. 4B, the portion by ½ of the sheet bundle 51 enters the nip region of the second folding roller pair 17b, the second fold 51b is formed in the nip region of the second folding roller pair 17b, and the Z-fold of the sheet bundle 51 is completed.

As illustrated in FIG. 4C, the sheet bundle 51 subjected to the Z-fold operation is conveyed from the second folding roller pair 17b to the sixth path 46. Subsequently, the sheet bundle 51 is conveyed upward in FIG. 4C (the downstream side in the sheet conveyance direction) along the sixth path 46 by the fourth conveyance roller pair 19. As illustrated in FIG. 4D, the sheet bundle 51 conveyed by the fourth conveyance roller pair 19 is stopped at the position of the fold-enhancing roller 20. The fold-enhancing roller 20 is rotated on the sheet bundle 51 stopped at the position, so that the crease (folded portion) of the second fold 51b is enhanced, and the fold-enhancing is thus performed. After the crease of the second fold 51b is enhanced by the fold-enhancing operation, the sheet bundle 51 is further conveyed so that the crease (folded portion) of the first fold 51a is also enhanced. The sheet bundle 51 with the creases of the first fold 51a and the second fold 51b being enhanced is conveyed by the fifth conveyance roller pair 21 to the first path 41, and is conveyed further downstream by the sixth conveyance roller pair 22 to the finisher 300.

Since the configuration of the sheet holding and reversing method and the sheet folding operation for performing, for example, half fold, three fold, and Z-fold using the first folding roller pair 17a and the second folding roller pair 17b described in the present embodiment are known, a detailed description is omitted here.

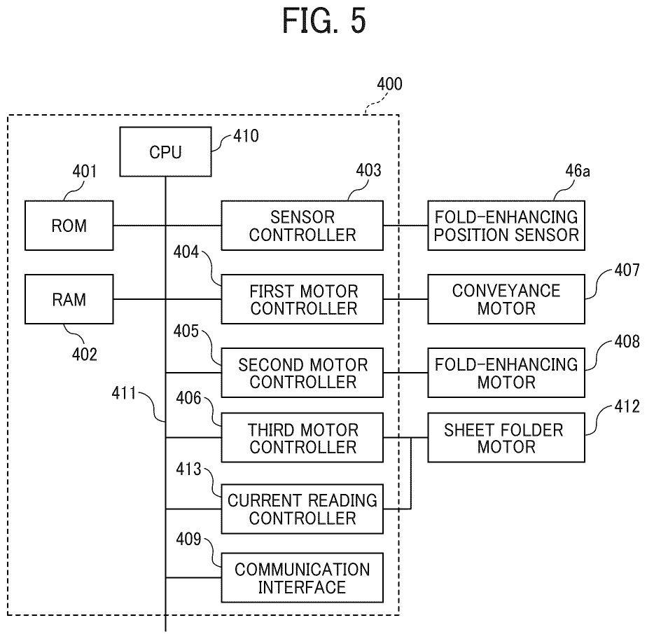

FIG. 5 is a block diagram illustrating a control circuit 400 of the sheet folding apparatus 100 according to the present embodiment.

The control circuit 400 of the sheet folding apparatus 100 includes a central processing unit (CPU) 410, a read only memory (ROM) 401, a random access memory (RAM) 402, a sensor controller 403, a first motor controller 404, a second motor controller 405, a third motor controller 406, a communication interface 409, and a current reading controller 413. The components of the control circuit 400 are electrically connected to each other via a bus line 411 such as an address bus or a data bus.

The sensor controller 403 is connected to a fold-enhancing position sensor 46a to monitor the detected state of the sheet 50 moving in the conveyance paths 40. The first motor controller 404 controls the driving of the conveyance motor 407 that drives the first conveyance roller pair 10, the second conveyance roller pair 12, the third conveyance roller pair 18, the fourth conveyance roller pair 19, the fifth conveyance roller pair 21, and the sixth conveyance roller pair 22. The second motor controller 405 controls the driving of a fold-enhancing motor 408 that drives to rotate the fold-enhancing roller 20. The third motor controller 406 controls the driving of a sheet folder motor 412 that drives to rotate the first folding roller pair 17a and the second folding roller pair 17b. The current reading controller 413 reads a current value (a value of a motor drive current) supplied to the sheet folder motor 412, and includes, for example, an analog-to-digital (A/D) converter that converts analog data of the current value into digital data.

The CPU 410 executes the computer-readable program stored in the ROM 401 (for example, the estimation program that will be described below) to control the sheet folding apparatus 100.

The ROM 401 stores, for example, data and programs to be executed by the CPU 410. The RAM 402 temporarily stores, for example, data when the CPU 410 executes a program. The communication interface 409 communicates with the image forming apparatus 200 and the finisher 300 and sends and receives data that is used for controlling the sheet folding apparatus 100.

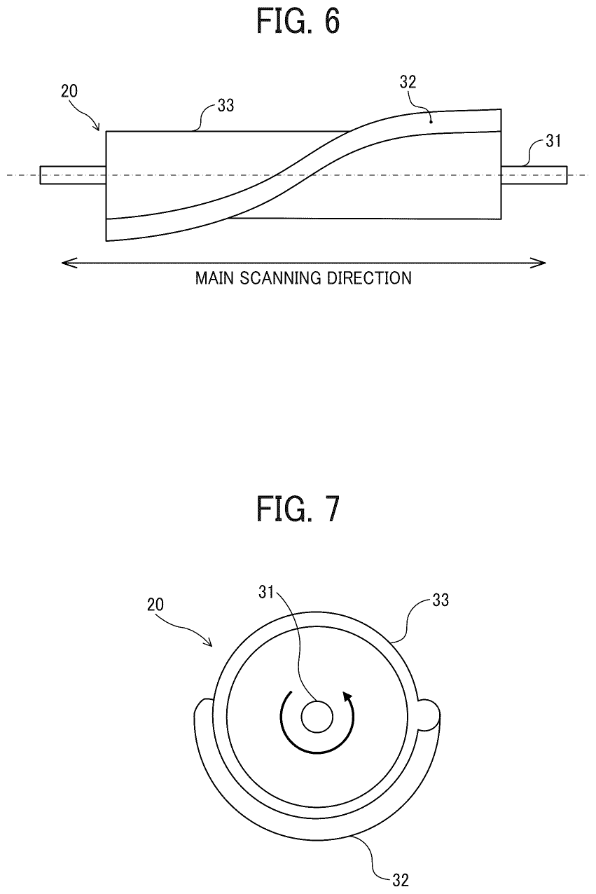

FIG. 6 is a front view of the fold-enhancing roller 20 included in the sheet folding apparatus 100.

FIG. 7 is a side view of the fold-enhancing roller 20.

In FIGS. 6 and 7, the fold-enhancing roller 20 includes a roller base 33 and a pressing force transmission portion 32. The roller base 33 is a roller that rotates about a roller rotation shaft 31. The pressing force transmission portion 32 having a ridge protruding in a spiral manner on the outer circumferential face of the roller base 33. In other words, the pressing force transmission portion 32 is disposed as a ridge protruding by a given amount on the outer circumferential face of the roller base 33 with a given angular difference from the axial direction of the roller rotation shaft 31. As a result, the pressing force transmission portion 32 is disposed extending in a spiral manner on the outer circumferential face of the roller base 33 along the roller rotation shaft 31. In the present embodiment, as illustrated in FIG. 7, the pressing force transmission portion 32 is not disposed over the entire circumference of the roller base 33, but is disposed over about half the circumference of the roller base 33.

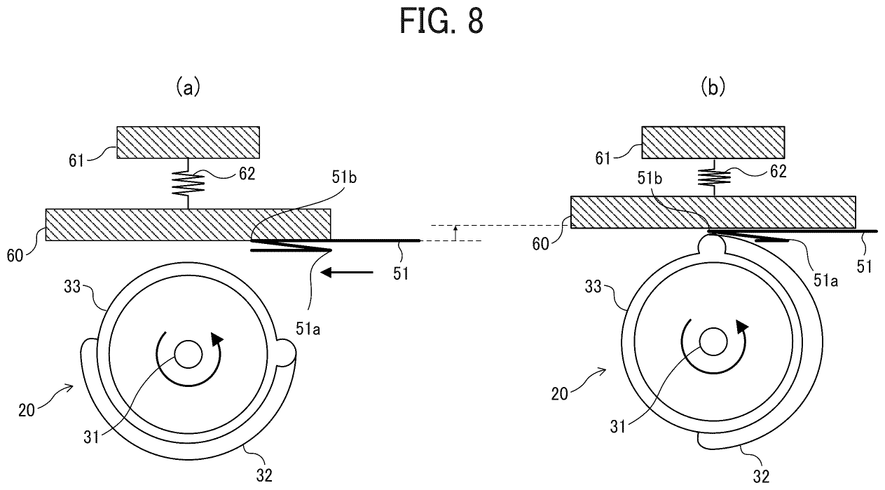

FIG. 8 including FIGS. 8 (a) and 8 (b) is a diagram illustrating the fold-enhancing operation by the fold-enhancing roller 20.

The sheet folding apparatus 100 according to the present embodiment includes a sheet supporting plate 60, a fixed member 61, and an elastic member 62. The elastic member 62 is attached to a position between the sheet supporting plate 60 and the fixed member 61 fixed to the sheet folding apparatus 100. The elastic member 62 expands and contracts (elastically deforms) in a direction in which the pressing force of the fold-enhancing roller 20 acts. The elastic member 62 may be an elastic body or an elastic structure that can apply a desired elastic force, such as a metal spring, a spring, or a synthetic resin elastic member. Further, in the present embodiment, the sheet supporting plate 60 is used, but it is needless to say that the effect of the present disclosure can be achieved even when the sheet supporting plate 60 has a roller shape.

When the sheet bundle 51 is conveyed from the position of FIG. 8 (a) of FIG. 8 to the position of FIG. 8 (b) of FIG. 8 and stops at the position of FIG. 8 (b), the fold-enhancing roller 20 rotates in the direction indicated by an arrow in FIGS. 8 (a) and 8 (b) of FIG. 8 (in the counterclockwise direction in FIG. 8 (b)). As a result, the pressing force transmission portion 32 contacts the sheet bundle 51 to push up the sheet supporting plate 60. When the sheet supporting plate 60 is pushed up, the elastic member 62 applies an elastic force to the crease (folded portion) of the second fold 51b of the sheet bundle 51, and the fold-enhancing operation is performed.

When the first fold 51a of the sheet bundle 51 is enhanced, the sheet bundle 51 is stopped at a position where the first fold 51a of the sheet bundle 51 is sandwiched between the pressing force transmission portion 32 of the fold-enhancing roller 20 and the sheet supporting plate 60. Then, the fold-enhancing roller 20 rotates in the direction indicated by the arrow in FIGS. 8 (a) and 8 (b) (counterclockwise in FIGS. 8 (a) and 8 (b)), and the elastic member 62 applies an elastic force to the crease (folded portion) of the first fold 51a of the sheet bundle 51. By so doing, the fold-enhancing operation is performed on the sheet bundle 51.

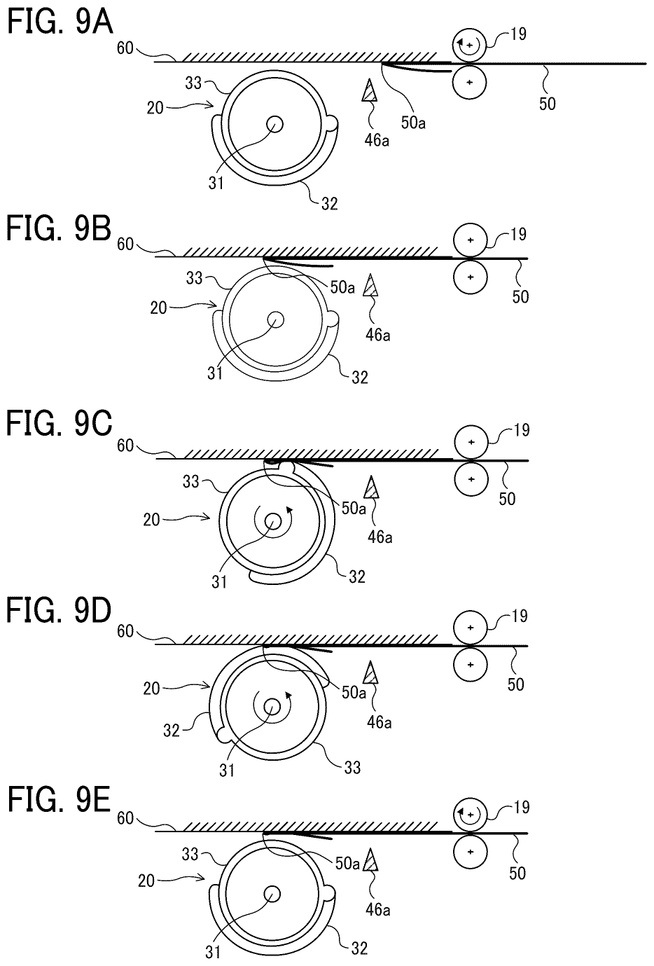

FIGS. 9A, 9B, 9C, 9D and 9E are operation diagrams illustrating the details of the fold-enhancing operation in the sheet folding apparatus 100.

A description is given of an example of the fold-enhancing operation for a single sheet 50 with one portion being folded.

As illustrated in FIG. 9A, the single sheet 50 with one portion being folded is conveyed by the fourth conveyance roller pair 19 to the fold-enhancing roller 20, from the right side to the left side in FIG. 9A (in practice, the sheet 50 is conveyed from the lower side to the upper side as illustrated in FIGS. 4A, 4B, 4C and 4D). This operation corresponds to the operation illustrated in FIG. 4C.

A fold-enhancing position sensor 46a is disposed at a given position upstream from the fold-enhancing roller 20 in the sheet conveyance direction. The fold-enhancing position sensor 46a functions as a leading end detection sensor to detect a leading end 50a of the sheet 50 in the sheet conveyance direction. The CPU 410 measures (counts) the output signal of an encoder that detects the amount of rotations of the conveyance motor 407 from the timing at which the fold-enhancing position sensor 46a detects the leading end 50a of the sheet 50. (no translation) When the CPU 410 of the sheet folding apparatus 100 determines that the leading end 50a of the sheet 50 reaches a position near the fold-enhancing roller 20, the driving of the conveyance motor 407 is stopped to stop the rotation of the fourth conveyance roller pair 19. As illustrated in FIG. 9B, this position is a fold-enhancing position (where the fold-enhancing roller 20 comes facing the sheet supporting plate 60 at the closest distance) to the leading end 50a of the sheet 50.

With the leading end 50a of the sheet 50 stopped at the fold-enhancing position as illustrated in FIG. 9B, the CPU 410 drives the fold-enhancing motor 408. As the fold-enhancing motor 408 starts driving, the fold-enhancing roller 20 starts rotating in a direction indicated by the arrow in FIG. 9B (counterclockwise direction in FIG. 9B), so that the pressing force transmission portion 32 contacts the crease (folded portion) in the leading end 50a of the sheet 50 that is stopped, and starts pressing the crease in the leading end 50a of the sheet 50. As a result, the fold-enhancing operation on the crease in the leading end 50a of the sheet 50 starts.

In the state illustrated in FIG. 9D, the fold-enhancing roller 20 is further rotated, and the pressing force transmission portion 32 presses the crease in the leading end 50a of the sheet 50 in the main scanning direction (the roller axial direction) from one end to the other end to enhance the crease in the sheet. When the fold-enhancing roller 20 is further rotated and the pressing force transmission portion 32 is separated from the leading end 50a of the sheet 50, the fold-enhancing operation to the other end of the crease in the sheet 50 is completed. In other words, the pressing point of the pressing force transmission portion 32 to the crease in the sheet 50 moves along the crease in the sheet 50 in the main scanning direction (the roller axial direction). Then, as illustrated in FIG. 9E, when the pressing force transmission portion 32 is separated from the sheet 50 and the fold-enhancing HP sensor detects the home position of the fold-enhancing roller 20, the CPU 410 causes the fold-enhancing motor 408 to stop to stop the rotation of the fold-enhancing roller 20. The fold-enhancing HP sensor is a sensor that detects the home position of the rotational position of the fold-enhancing roller 20. As described above, the pressing force transmission portion 32 contacts the sheet supporting plate 60 to start pressing the crease in the sheet 50, as illustrated in FIG. 9C, and is separated from the sheet supporting plate 60. At this timing, one round of the fold-enhancing operation is completed.

A description is given below of a control of the sheet folding operation according to the present embodiment.

In order to enhance the folding quality of a sheet in the sheet folding apparatus 100, it needs to appropriately select and execute the sheet folding contents (for example, the number of times of fold-enhancing by the fold-enhancing roller 20) according to various conditions. For example, differences in sheet kinds such as sheet size, thickness, stiffness, glossiness, and smoothness affect the result of the sheet folding operation (for example, the folding quality). For this reason, such differences are highly desired conditions for an appropriate selection of the sheet folding contents. Further, since a difference in the sheet folding contents such as the folding kind, the number of times of the multi-folding operations of overlapped sheets, the number of times of the fold-enhancing operations, a fold-enhancing stop position in the sheet folding operation also affects the result of the sheet folding operation, such a difference is a highly desired condition for an appropriate selection of the sheet folding contents.

Since there are various conditions for an appropriate selection of the sheet folding contents for each use state of the user, the number of combinations of the conditions is enormous. In addition, there are, for example, users who use a special kind of sheet that is not distributed in the market, users who use a special folding kind, and users who have a special setting of a target height of fold of a sheet or sheets. For the above-described reasons, it is practically difficult to grasp appropriate sheet folding contents by performing, for example, a test in advance for all combinations.

For this reason, the typical method of appropriately selecting the sheet folding contents according to the appropriate sheet folding content for each combination grasped in advance by, for example, a preliminary test may not cope under various usage conditions of each user, and the sheet folding contents may not be appropriately selected in some cases. In a case where the sheet folding contents may not be appropriately selected, for example, the fold-enhancing operation is insufficient, the height of fold of a sheet or sheets may not be sufficiently reduced due to the insufficient fold-enhancing operation, and the folding quality may not be obtained in some cases. Further, for example, excessive fold-enhancing may cause a deterioration in productivity and wasteful consumption of electric power.

In the present embodiment, the sheet information of the sheet on which the sheet folding operation is performed in the sheet folding apparatus 100 and the folding information indicating the sheet folding contents are acquired before completion of the sheet folding operation, and the folding evaluation value after the sheet folding operation on the sheet is estimated in advance. Then, based on the folding evaluation value estimated in advance, the control contents for the sheet folding operation on the sheet is determined, and the sheet folding operation on the sheet is controlled with the determined control contents. Accordingly, the folding evaluation value related to the evaluation result of the folding quality of the sheet folding operation on the sheet to be folded is estimated in advance. Accordingly, the sheet folding contents on the sheet can be adequately adjusted according to the folding evaluation value.

In addition, in the pre-estimation of the folding evaluation value in the present embodiment, a trained model created by, for example, machine learning is used as an estimation program. In addition, the trained model obtained by using multiple training datasets including the sheet information of the sheets for training, the folding information of the sheets for training, and the folding evaluation value after the sheet folding operation on the sheets for training is used.

In the step of creating the trained model according to the present embodiment (training phase), the sheet folding operation is performed in advance using various sheets for training with various sheet folding contents, and the quality of each sheet folding is evaluated to obtain the folding evaluation value. Then, for example, machine learning is executed using the training datasets including multiple (large number of) training datasets including the sheet information, the folding information, and the folding evaluation values, so as to obtain the trained model. The trained model obtained as described above is an estimation program in which the sheet information of the sheet and the folding information of the sheet folding contents are as input data and the folding evaluation value after the sheet folding operation to be estimated is as output data.

According to the trained model in the present embodiment, even if the sheet kinds or the sheet folding contents do not match the sheet information and the folding information used as the training datasets when the sheet folding operation on a processing target sheet is actually performed, the folding evaluation value indicating the folding quality after the sheet folding operation can be estimated with high accuracy. Accordingly, even if the conditions (e.g., sheet kind, the sheet folding contents) for appropriately selecting the sheet folding contents are various for each user's usage, the folding quality after the sheet folding operation under the various usage conditions of each user can be grasped in advance, and the sheet folding contents can be appropriately adjusted. Accordingly, the sheet processing apparatus according to the first aspect can appropriately select the sheet folding contents and execute an appropriate sheet folding operation under the various usage conditions of each user.

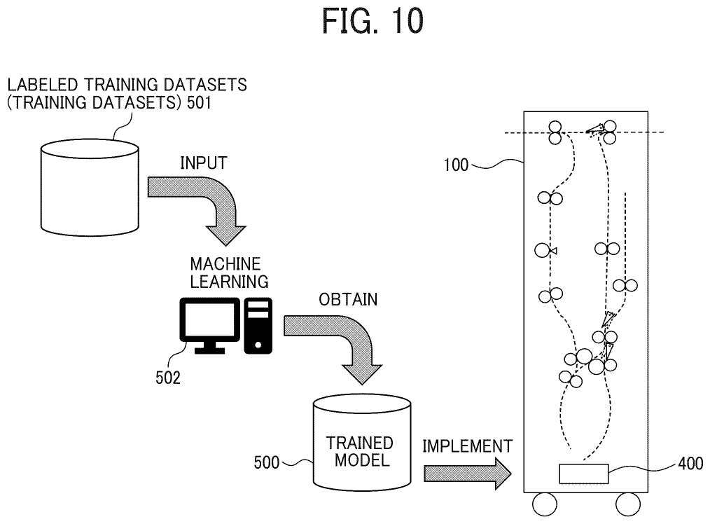

FIG. 10 is a diagram illustrating the training phase of the trained model 500 executed by the CPU 410 of the control circuit 400 in the sheet folding apparatus 100.

The trained model 500 according to the present embodiment can be created by supervised learning (machine learning) using, for example, an external personal computer 502 or a cloud service capable of generating the trained model 500. The trained model 500 to be created is a kind of calculation algorithm, and is implemented as a module as a part of a control program (estimation program) executed by the CPU 410.

As an example of supervised learning, various types (for example, size, thickness, paper kind) of sheets for training are used, and the minimum number of times of fold-enhancing operations with which a target height of fold of a sheet or sheets (folding evaluation value) is obtained is specified for various sheet folding contents (for example, folding type and the number of times of multi-folding operations of overlapped sheets overlapped sheets). As a result, various kinds (e.g., size, thickness, sheet type) of sheets for training are used to obtain labeled training datasets in which the height of fold (folding evaluation value) when the sheet folding operation is performed with various sheet folding contents (e.g., folding pattern, the number of times of multi-folding operations of overlapped sheets, the least number of fold-enhancing operations) is the determined data.

The present embodiment describes an example of the trained model 500 created by supervised learning (machine learning). However, a trained model 500 may be created by employing different machine learning such as non-supervised learning or reinforcement learning. In the present embodiment, the height of fold of a sheet or sheets after the sheet folding operation is used as a folding evaluation value. Alternatively, another folding evaluation value that can evaluate the results of the sheet folding operation may be used.

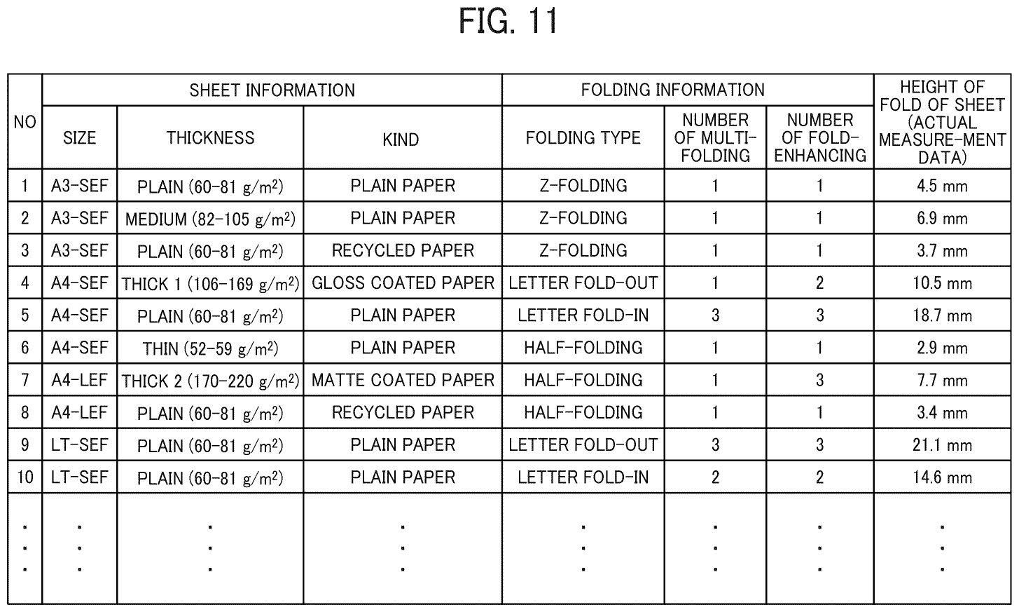

FIG. 11 is a diagram illustrating a table of an example of the labeled training datasets used as the training datasets for the trained model 500.

In the example illustrated in FIG. 11, data such as the sizes (sheet sizes), the thicknesses (sheet thicknesses), and kinds (sheet kinds) of sheets that can be folded by the sheet folding apparatus 100 is used as the sheet information.

This sheet information is an example of sheet information that can be set in a typical image forming apparatus 200. The sheet information may include other sheet characteristics that affect the height of fold of the sheet (folding evaluation value), and data such as stiffness, glossiness, and smoothness.

The sheet information can use data obtained by sensing the sheet by a sensor in the image forming system (for example, the sheet folding apparatus 100 and the image forming apparatus 200).

For example, the thickness (sheet thickness) as the sheet information can be measured by a known thickness detector (for example, Japanese Patent Application Laid-Open No. 2010-070374). Further, for example, a unit for discriminating a sheet brand can be used as disclosed in Japanese Patent Laid-Open No. 2015-021766, so that data such as glossiness and smoothness obtained from the discriminated sheet brand can be acquired as sheet information.

In the example illustrated in FIG. 11, data such as the folding pattern that can be folded by the sheet folding apparatus 100, the number of times of multi-folding operations of overlapped sheets, and the number of times of fold-enhancing operations is used as the folding information. The folding information is an example of the sheet folding contents that can be set in the sheet folding apparatus 100 according to the present embodiment. Data of other sheet folding contents that affect the height of fold of the sheet (folding evaluation value), for example, the pressing force and the pressure time when the sheet folding operation or the fold-enhancing operation is performed, the relative position information of the fold-enhancing mechanism and the crease (folded portion) may be used as sheet information.

Further, the labeled training datasets (training datasets for the trained model 500) in the training phase of the trained model 500 need to include output data (determined data) to be received in the inference phase in addition to the sheet information and the folding information. In the present embodiment, in order to use the height of fold (folding evaluation value) as output data in the inference phase, actual measurement data of the height of fold after the folding processing is performed under the conditions of the respective sheet information and folding information is added as the determined data to the training datasets, so as to be analyzed by machine learning.

When the trained model 500 is executed by the CPU 410 (in the inference phase), the control circuit 400 of the sheet folding apparatus 100 acquires the sheet information and the folding information of a processing target sheet (sheet to be folded by the sheet folding apparatus 100). As an acquisition method, for example, the control circuit 400 of the sheet folding apparatus 100 acquires the sheet information and the folding information input by the user via the communication with the control circuit 206 of the image forming apparatus 200 through the display 201 and the control panel 202 on the image forming apparatus 200. Such the display 201 and the control panel 202 may be disposed on the sheet folding apparatus 100.

Further, in a case where the sheet information from the above-described thickness detector or a unit that discriminates the sheet brand is used, these units included in the image forming apparatus 200 can be used.

In this case, the sheet information obtained based on detection (sensing) of the thickness detector or a unit that discriminates the sheet brands may be acquired by the control circuit 400 of the sheet folding apparatus 100 through communication from the control circuit 206 of the image forming apparatus 200. These units may be disposed on the sheet folding apparatus 100.

Further, the labeled training datasets (the training datasets for the trained model 500) in the training phase of the trained model 500 may include driving state information indicating the driving state of the sheet folder during the execution of the sheet folding operation.

As the driving state information, for example, a drive current value of the sheet folder motor 412 read by the current reading controller 413 may be used as the driving state information of the sheet folder motor 412 that drives the first folding roller pair 17a and the second folding roller pair 17b. In this case, when the trained model 500 is executed in the sheet folding apparatus 100 (inference phase), the drive current value of the sheet folder motor 412 read by the current reading controller 413 is also used as input data of the trained model.

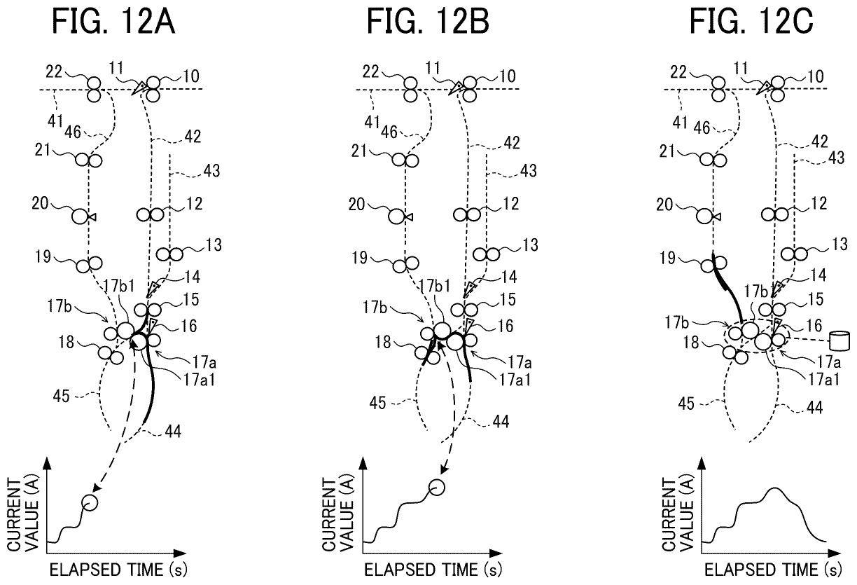

FIGS. 12A, 12B and 12C are diagrams illustrating positions and movements of a sheet in the Z-folding operation and the time changes (current waveforms) in a drive current value of the sheet folder motor 412.

In the present embodiment, as illustrated in FIG. 12C, the first folding roller pair 17a and the second folding roller pair 17b are driven by a single sheet folder motor 412.

FIG. 12A illustrates a state of the first fold in the Z-folding.

When the bend portion of a sheet to be folded as a first fold of the sheet is nipped by the nip region of the roller pair including the roller 17al of the first folding roller pair 17a and the roller 17b1 of the second folding roller pair 17b, the load of the sheet folder motor 412 increases, and the drive current value read by the current reading controller 413 increases.

FIG. 12B illustrates a state of the second fold in the Z-folding.

When the bend portion of a sheet to be folded as a second fold of the sheet is nipped by the nip region of the second folding roller pair 17b, the load of the sheet folder motor 412 further increases, and the drive current value read by the current reading controller 413 further increases.

FIG. 12C illustrates that the Z-folding is completed, and the sheet has passed through the second folding roller pair 17b.

With the sheet subjected to the Z-folding operation illustrated in FIG. 12C, the load of the sheet folder motor 412 decreases, and the drive current value read by the current reading controller 413 decreases.

The amount of increase in the drive current value of the sheet folder motor 412, which increases during the sheet folding operation, correlates with the thickness of the sheet that affects the result of the sheet folding operation, and tends to increase as the sheet thickness increases. In addition, the amount of increase in the drive current value correlates with the number of sheets to be folded together in a multi-sheet folding, which affects the result of the sheet folding operation, and tends to increase as the number of sheets to be folded together increases. For these reasons, the drive current value of the sheet folder motor 412 can be a significant condition for appropriate selection of the sheet folding contents.

In particular, the individual difference of the sheet or the range of variation in the sheet thickness may not be strictly distinguished only by the information of the sheet thickness. For example, the same sheet thickness information “plain paper (60 to 81 g/m²)” is given to both of a sheet having the sheet thickness of 60 g/m² and a sheet having the sheet thickness of 81 g/m². However, there is a significant difference in the actual sheet thickness, and a difference occurs in the result of the sheet folding operation (height of fold of a sheet or sheets). On the other hand, the difference in the actual sheet thickness appears as a difference in the drive current value of the sheet folder motor 412. For these reasons, using the drive current value of the sheet folder motor 412 as a part of the labeled training datasets 501 is useful in enhancing the accuracy of estimation of the folding evaluation value by the trained model 500.

Even if the input information of the sheet thickness is not correct, using the drive current value of the sheet folder motor 412 as a part of the labeled training datasets 501 can reduce the impact of the mistake and enhance the accuracy of estimation of the folding evaluation value by the trained model 500.

Further, the pressing force of the first folding roller pair 17a and the second folding roller pair 17b may be changed due to the variation or deterioration of the pressing unit such as a spring for forming the nip of the first folding roller pair 17a and the second folding roller pair 17b. Even in such cases, using the drive current value of the sheet folder motor 412 as a part of the labeled training datasets 501 can obtain the trained model 500 that can estimate the height of fold of a sheet or sheets (folding evaluation value) according to the change. Accordingly, the estimation accuracy of the folding evaluation value by the trained model 500 can be enhanced.

Further, since the timings at which the sheet is nipped by the first folding roller pair 17a and the second folding roller pair 17b are different depending on the folding pattern, the time variation of the drive current value of the sheet folder motor 412 is also different depending on the folding pattern. For the above reasons, using the drive current value of the sheet folder motor 412 as a part of the labeled training datasets 501 can obtain the trained model 500 that can estimate the height of fold of a sheet or sheets (folding evaluation value) by adding information of the folding pattern. Accordingly, the estimation accuracy of the folding evaluation value by the trained model 500 can be enhanced.

Further, the drive current value of the sheet folder motor 412 varies depending on the number of times of multi-folding operations of overlapped sheets to be folded together. For the above reasons, using the drive current value of the sheet folder motor 412 as a part of the labeled training datasets 501 can obtain the trained model 500 that can estimate the height of fold of a sheet or sheets (folding evaluation value) by adding information of the number of times of multi-folding operations of overlapped sheets to be folded together. Accordingly, the estimation accuracy of the folding evaluation value by the trained model 500 can be enhanced.

Further, the labeled training datasets (the training datasets for the trained model 500) in the training phase of the trained model 500 may include environmental information including at least one of temperature or humidity.

(no translation) In this case, when the trained model 500 is executed in the sheet folding apparatus 100 (inference phase), environmental information detected by an environmental information detector such as a temperature sensor or a humidity sensor is also used as input data of the trained model.

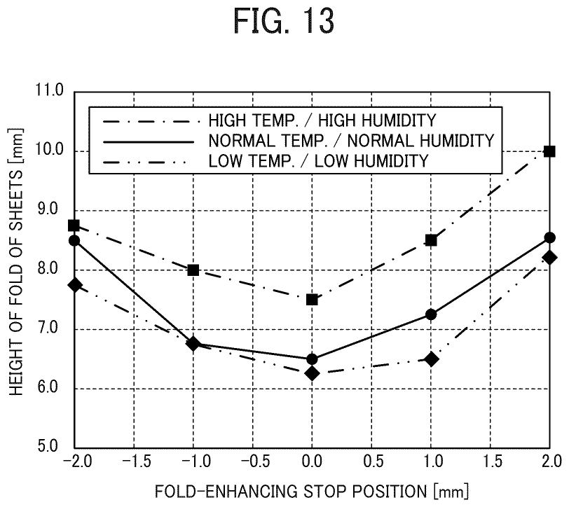

FIG. 13 is a graph illustrating an influence on the folding height at a fold-enhancing stop position depending on a difference in environmental information including temperature and humidity.

In this example, evaluation was performed in three environments, which are a high-temperature and high-humidity environment, a normal-temperature and normal-humidity environment, and a low-temperature and low-humidity environment. The fold-enhancing stop position is a stop position of a sheet to the fold-enhancing roller 20 and a distance in the sheet conveyance direction between the contact position of the pressing force transmission portion 32 of the fold-enhancing roller 20 and the sheet supporting plate 60 and a position at which the fold of the sheet is stopped.

As illustrated in the table of FIG. 13, it is clear that, when the environment (temperature and humidity) changes, a difference of 1 mm or more may occur in the height of fold (fold evaluation value) even at the same fold-enhancing stop position. For this reason, the environmental information may be a significant condition for appropriate selection of the sheet folding contents. Accordingly, using the environmental information as a part of the labeled training datasets 501 is useful in enhancing the accuracy of estimation of the folding evaluation value by the trained model 500.

Further, as illustrated in the table of FIG. 13, it is clear that, when the fold-enhancing stop position changes, the height of fold (folding evaluation value) may be affected even in the same environment (same temperature and humidity). For this reason, the fold-enhancing stop position may also be a significant condition for appropriate selection of the sheet folding contents. Accordingly, using the fold-enhancing stop position as a part of the labeled training datasets 501 is useful in enhancing the accuracy of estimation of the folding evaluation value by the trained model 500.

A description is given below of an estimation phase using the trained model 500 according to the present embodiment.

In the present embodiment, when the sheet folding apparatus 100 receives the sheet 50 from the image forming apparatus 200 and performs the sheet folding operation, the trained model 500 generated by the machine learning in the above-described training phase is executed by the control circuit 400, and the height of fold of a sheet or sheets (folding evaluation value) after the sheet folding operation is estimated (predicted). Specifically, when the sheet information and the folding information of the sheet 50 are input and set via the control panel 202 of the image forming apparatus 200, the set data (the sheet information and the folding information) is given to the trained model 500 as input data. As a result, the trained model 500 outputs, as output data, a predicted value of the height of fold (folding evaluation value) when the sheet 50 is folded by the sheet folding apparatus 100.

The control circuit 400 executes a control program of the sheet folding apparatus 100, and perform a process for determining, for example, whether or not this predicted value of the height of fold falls within a target range of the height of fold (for example, the range of the specified value of a product), from the predicted value of the height of fold output from the trained model 500. Further, the control circuit 400 performs a process for determining, from the predicted value of the height of fold, whether or not a failure such as an early full state occurs when the sheets 50 to be folded together at the height of fold of the predicted value are stacked on the sheet stacking tray 303.

When the control circuit 400 determines, based on the predicted value of the height of fold, that the height of fold is not sufficiently reduced, which brings the height of fold to be out of the target range of the height of fold or causes a failure such as an early full state, the control circuit 400 determines the control content for reducing the height of fold. For example, the control circuit 400 changes the control content by increasing the number of times of the fold-enhancing operations, increasing the pressing force in the fold-enhancing operations, or increasing the pressing time in the fold-enhancing operations, as compared with the current setting (sheet folding contents).

On the other hand, when the control circuit 400 determines, based on the predicted value of the height of fold, that the height of fold is sufficiently reduced and the fold-enhancing is excessively performed, the control circuit 400 determines the control content in which the productivity and the energy-saving performance are prioritized. For example, the control circuit 400 changes the control contents by decreasing the number of times of the fold-enhancing operations, decreasing the pressing force in the fold-enhancing operations, or decreasing the pressing time in the fold-enhancing operations, as compared with the current setting (sheet folding contents).

In the present embodiment, the control content of the sheet folding in the fold-enhancing operation by the fold-enhancing roller 20 is changed (determined) from the predicted value of the height of fold output by the trained model 500. Alternatively, the control content of the sheet folding in the sheet folding operation by, for example, the first folding roller pair 17a and the second folding roller pair 17b may be changed (determined). For example, the height of fold may be changed by changing, for example, the pressing force or the pressing time (sheet conveyance speed) in the sheet folding operation.

As described in the present embodiment, when the height of fold (folding evaluation value) after the sheet folding operation is estimated (predicted) by using the trained model 500 by machine learning, even if the sheet folding operation is for a combination that is not included (not expected) in the combination of the sheet information and the folding information included in the training datasets that are used in the training phase of the trained model 500, the height of fold after that sheet folding operation (folding evaluation value) can be estimated (predicted). For example, coated paper is generally thicker than medium paper in many cases due to the structure in which the surface of the paper is coated with paint. However, there is a possibility that the user may obtain thin coated paper (not used as a sheet for training) and use the thin coated paper in the sheet folding apparatus 100. Even in such a usage status of the user, the trained model 500 can estimate (predict) the height of fold when the sheet folding operation is performed on the thin coated paper. Accordingly, even in the usage status of the user who instructs the sheet folding operation on the unexpected sheet such as a thin coated paper, the sheet folding contents on the unexpected sheet (for example, the number of times of the fold-enhancing operations) can be appropriately adjusted, from the predicted value of the height of fold obtained by the trained model 500.

### Modification 1

A description is given below of the configuration and operation of the sheet folding apparatus 100 according to a modification of the image forming system according to the present embodiment. This modification is referred to as “Modification 1.”

In the above-described embodiment, the sheet information of the sheets for training used in the training phase and the sheet information of the sheet (the processing target sheet) 50 used in the inference phase are sheet information input by the user. In Modification 1, a description is given of an example of at least a part of sheet information using sheet information obtained from the detection result of a sheet information detector. Further, in Modification 1, the environmental information including at least one of temperature or humidity detected by an environmental information detector is also used.

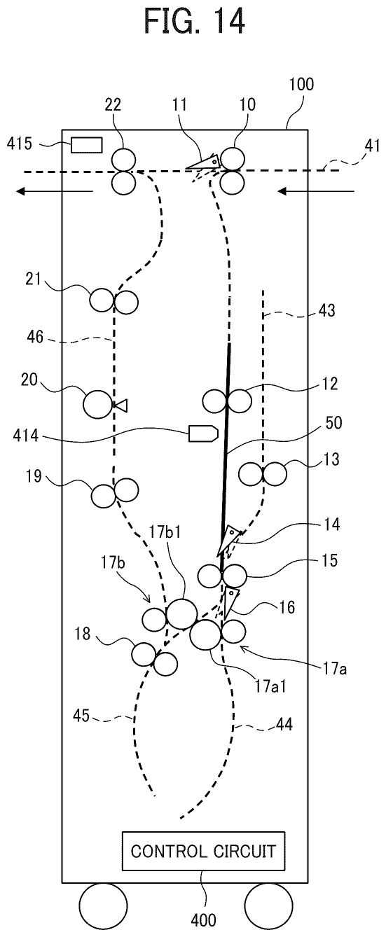

FIG. 14 is a diagram illustrating the sheet folding apparatus 100 according to Modification 1.

The sheet folding apparatus 100 according to Modification 1 includes a glossiness sensor 414 and a temperature sensor 415. The glossiness sensor 414 functions as a sheet information detector that can detect glossiness of a sheet (sheet information). The temperature sensor 415 functions as an environmental information detector to detect the temperature in the environment where the sheet folding apparatus 100 is installed.

The glossiness sensor 414 is a sensor that irradiates the surface of the sheet 50 with light and detects the intensity of the reflection light, and can determine that the glossiness is higher as the reflection light is stronger. When the glossiness sensor 414 is used, more accurate data can be acquired when the sheet 50 is stopped, as compared to when the sheet 50 is moving. For this reason, in the sheet folding apparatus 100 according to Modification 1, the glossiness sensor 414 is upstream from the registration roller pair 15 in the sheet conveyance direction. When the leading end of the sheet 50 is brought to contact the registration roller pair 15 to stop the sheet 50 so that the sheet folding apparatus 100 corrects skew of the sheet 50, the glossiness sensor 414 acquires the glossiness of the sheet 50. Instead of the glossiness sensor 414, a sensor capable of detecting other sheet characteristics such as the stiffness and smoothness of the sheet 50 may be employed, or various types of sensors capable of detecting different sheet characteristics may be used in combination.

The temperature sensor 415 is a sensor to detect an environmental temperature of the area around the temperature sensor 415. The inside of the sheet folding apparatus 100 is likely to have a temperature higher than the outside temperature (external temperature) since, for example, the sheet 50 that is heated by the fixing device 205 of the image forming apparatus 200 is conveyed or heat is generated when motors are driven. For these reasons, when the temperature is acquired as the environmental information, the temperature sensor 415 is preferably disposed at a position where the temperature sensor 415 is less susceptible to the effect by the temperature. In Modification 1, as illustrated in FIG. 14, the temperature sensor 415 is disposed near the extreme downstream area of the sheet folding apparatus 100 (near the sheet transfer exit port of the sheet folding apparatus 100) in the sheet conveyance direction. Instead of the temperature sensor 415, a sensor that detects humidity as environmental information may be employed, or various types of sensors capable of detecting different environmental information from each other (for example, temperature and humidity) may be used in combination.

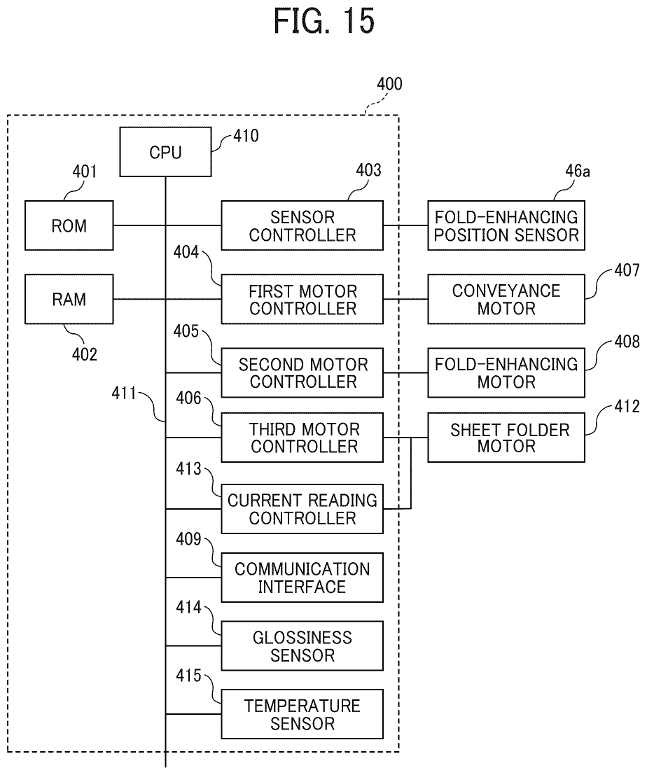

FIG. 15 is a block diagram illustrating the control circuit 400 of the sheet folding apparatus 100 according to Modification 1.

In the control circuit 400 of Modification 1, the glossiness sensor 414 and the temperature sensor 415 are electrically connected to the CPU 410 via the bus line 411. As a result, data acquired by the glossiness sensor 414 and the temperature sensor 415 can be used as sheet information and environmental information.

The glossiness sensor 414 and the temperature sensor 415 may be disposed in the image forming apparatus 200. In this case, the data obtained based on the detection results of the glossiness sensor 414 and the temperature sensor 415 may be acquired by the control circuit 400 of the sheet folding apparatus 100 through communication from the control circuit 206 of the image forming apparatus 200.

### Modification 2

A description is given below of the configuration and operation of the sheet folding apparatus 100 according to another modification of the image forming system according to the present embodiment. This modification is referred to as “Modification 2.”

For example, when the control circuit 400 determines to increase or decrease the number of times of the fold-enhancing operations in the sheet folding operation, from the predicted value of the height of fold obtained by the trained model 500, the time for the fold-enhancing operations by the fold-enhancing roller 20 increases or decreases depending on the determination. As a result, the sheet interval (sheet interval time) of the sheet 50 and a subsequent sheet changes.

In Modification 2, the control circuit 400 adjusts the sheet interval (sheet interval time) in the sheet folding apparatus 100 according to the control contents of the sheet folding operation (for example, the number of times of the fold-enhancing operations) determined by the height of fold (folding evaluation value) after the sheet folding operation output by the trained model 500. In Modification 2, the sheet receiving interval of the sheet folding apparatus 100 according to the control contents that the control circuit 400 has determined is notified to the image forming apparatus 200, so that the sheet interval time is adjusted in the image forming apparatus 200.

However, when the drive current value of the sheet folder motor 412 is used or when glossiness detected by the glossiness sensor 414 is used, the predicted value of the height of fold after the sheet folding operation from the trained model 500 can be obtained only after the sheet (the processing target sheet) 50 is received by the sheet folding apparatus 100. Accordingly, the control contents of the sheet folding operation (for example, the number of times of the fold-enhancing operations) that the control circuit 400 determines from the predicted value of the height of fold obtained by the trained model 500 is to be determined at least after the sheet folding apparatus 100 receives the sheet 50.

For this reason, the sheet interval time in consideration of the above-described case is to be obtained.

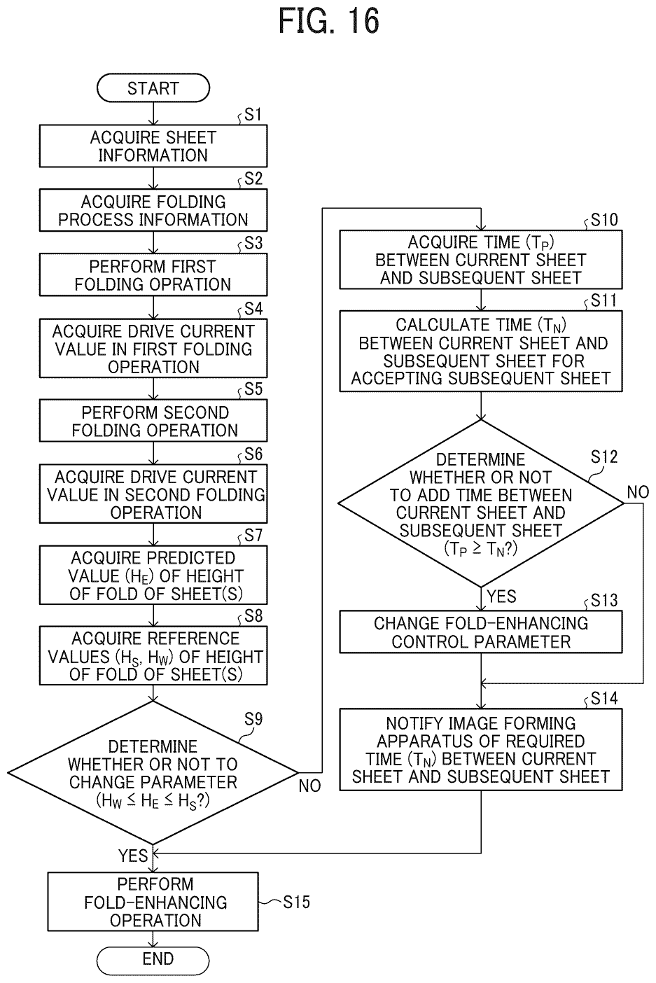

FIG. 16 is a flowchart of a flow of a control related to an adjustment of time between sheets in the sheet folding apparatus 100 according to Modification 2.

Modification 2 is an example of using a drive current value of the sheet folder motor 412 and performing Z-fold in the sheet folding operation.

Since the sheet information and the folding information input by the user are confirmed when the sheet folding apparatus 100 receives the sheet 50, the control circuit 400 of the sheet folding apparatus 100 can acquire the sheet information (step S1), and the folding information (step S2). However, only after the sheet folding apparatus 100 performs a first fold 51a of the Z-fold operation, which is a first sheet folding operation (step S3), the control circuit 400 is allowed to acquire the drive current value of the sheet folder motor 412 in the first sheet folding operation (step S4). Then, after the sheet folding apparatus 100 performs a second fold 51b of the Z-fold operation, which is a second sheet folding operation (step S4), the control circuit 400 is allowed to acquire the drive current value of the sheet folder motor 412 in the second sheet folding operation (step S5). For this reason, in Modification 2, the control circuit 400 acquires the drive current value of the sheet folder motor 412 after the first sheet folding operation (step S4), and acquires the drive current value of the sheet folder motor 412 after the second sheet folding operation (step S6).

Since information to be input to the trained model 500 is prepared at the time when the control circuit 400 acquires the drive current value of the sheet folder motor 412 (step S6), a predicted value (H_{E}) of the height of fold is acquired from the trained model 500 (step S7). Then, the control circuit 400 determines a fold-enhancing control parameter that is control contents of the sheet folding operation, based on the predicted value (H_{E}) of the height of fold predicted by the trained model 500.

Specifically, the control circuit 400 first acquires an enhancement reference value (H_{S}) and a relaxation reference value (H_{W}) as reference values of the height of fold to determine whether or not the fold-enhancing control parameter such as the number of times of the fold-enhancing operations, the pressing force, the pressing time in the fold-enhancing operations is to be changed (step S8). Then, the predicted value (H_{E}) of the height of fold is compared to the enhancement reference value (H_{S}) and the relaxation reference value (H_{W}), so that it is determined whether the fold-enhancing control parameter is to be changed (step S9).

In this determination, when it is determined that the sheet folding contents (fold-enhancing control parameter) included in the folding information that is acquired in step S2 is not to be changed (YES in step S9), the fold-enhancing operation is performed (step S15), and ends the process in the flowchart of FIG. 16.

On the other hand, when it is determined that the sheet folding contents (fold-enhancing control parameter) is to be changed (NO in step S9), the sheet interval time (T_{P}) with the subsequent sheet is acquired first (step S10), and the required sheet interval time (T_{N}) for receiving the subsequent sheet is calculated (step S11). Then, it is determined whether the sheet interval time (T_{P}) between the current sheet and the subsequent sheet is equal to or greater than the required sheet interval time (T_{N}), in other words, it is determined whether to add time to the sheet interval time (T_{P}) between the current sheet and the subsequent sheet (step S12). When the sheet interval time (T_{P}) between the current sheet and the subsequent sheet is equal to or greater than the required sheet interval time (T_{N}) (YES in step S12), the time is not to be added to the sheet interval time (T_{P}). Accordingly, the fold-enhancing control parameter is changed to a new parameter (step S13), and the fold-enhancing operation is performed (step S15). At this time, since the required sheet interval time (T_{N}) may be shortened when the number of times of the fold-enhancing operations is reduced, the control circuit 400 notifies the control circuit 206 of the image forming apparatus 200 of the required sheet interval time (T_{N}) (step S14).

If the sheet interval time (T_{P}) between the current sheet and the subsequent sheet is less than the required sheet interval time (T_{N}) (NO in step S12), the sheet interval time needs to be added. In this case, only the required sheet interval time (T_{N}) is notified to the image forming apparatus 200 (step S14), and the fold-enhancing operation is performed without changing the fold-enhancing control parameter (step S15).

The image forming apparatus 200 adjusts the sheet interval time of the sheet to be ejected to the sheet folding apparatus 100 (the sheet to be received by the sheet folding apparatus 100) by, for example, adjusting the timing of feeding the sheet from the sheet feeding device 203 in which the sheets for printing are stacked, according to the notified required sheet interval time (T_{N}). The sheet interval between the sheets that have already been fed may not be changed, but the sheet to be newly fed can be applied to the required sheet interval time (T_{N}) notified from the sheet folding apparatus 100. Accordingly, when the time at which the sheet folding apparatus 100 receives the sheet subjected to the sheet interval adjustment comes, the sheet folding apparatus 100 changes the fold-enhancing control parameter to a new control parameter, and the fold-enhancing operation is performed with the new control parameter.

The required sheet interval time may be determined in consideration of the processing time that increases or decreases according to the changed fold-enhancing control parameter with respect to the initial setting value of the fold-enhancing control parameter. For example, when the number of times of the fold-enhancing operations as the fold-enhancing control parameter is increased, the time required for the fold-enhancing roller to rotate one cycle may be added. On the other hand, when the number of times of the fold-enhancing operations as the fold-enhancing control parameter is decreased, the time required for the fold-enhancing roller to rotate one cycle may be subtracted.

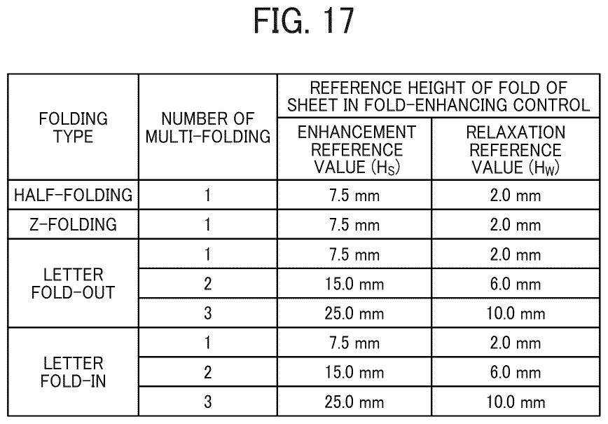

FIG. 17 is a table of an example of reference values of the folding height for determining whether or not a fold-enhancing control parameter is to be changed in Modification 2.

For example, when the predicted value (H_{E}) of the height of fold when a sheet is to be folded as half fold is 10.0 mm, the predicted value (H_{E}) is beyond the enhancement reference value (H_{S}). Thus, it is determined that the fold-enhancing control parameter needs to be changed in order to reduce the height of fold in the fold-enhancing operation. In this case, for example, the number of times of the fold-enhancing operations (the number of times of driving of the fold-enhancing roller 20) is added to reinforce (enhance) the line of the fold, so that the height of fold is reduced.

For example, when the predicted value (H_{E}) of the height of fold when a sheet is to be folded as letter fold-in is 8.0 mm, the predicted value (H_{E}) is lower than the relaxation reference value (H_{W}). Thus, it is determined that the fold-enhancing control parameter needs to be changed in order to prioritize the productivity of the sheet folding apparatus 100. In this case, for example, the number of times of the fold-enhancing operations is reduced to enhance the productivity.

The reinforcement reference value (H_{S}) and the relaxation reference value (H_{W}) of the height of fold may be set and changed via the control panel 202 in order to enhance the usability for the user. For example, a user who wants to increase the number of sheets stacked on the sheet stacking tray 303 may change the enhancement reference value (H_{S}) and the relaxation reference value (H_{W}) to smaller values. As a specific example, the user may select an option such as “priority mode for the number of stacked sheets” as an option of the control panel 202.

Further, for example, a user who wants to prioritize the productivity of the sheet folding apparatus 100 by reducing the time for the sheet folding operation of the sheet may change the threshold values of the enhancement reference value (H_{S}) and the relaxation reference value (H_{W}) to large values. As a specific example, the user may select an option such as “productivity priority mode” as an option of the control panel 202.

In a case where the power consumption changes by changing the fold-enhancing control parameter, an option such as “energy-saving priority mode” may be provided.

### Modification 3

A description is given below of the configuration and operation of the sheet folding apparatus 100 according to yet another modification of the image forming system according to the present embodiment. This modification is referred to as “Modification 3.”

In Modification 3, as in Modification 2 described above, the control circuit 400 adjusts the sheet interval (sheet interval time) in the sheet folding apparatus 100 according to the control contents of the sheet folding operation (for example, the number of times of the fold-enhancing operations) determined by the height of fold (folding evaluation value) after the sheet folding operation output by the trained model 500. In Modification 3, however, the sheet interval time is adjusted by the operation in the sheet folding apparatus 100.

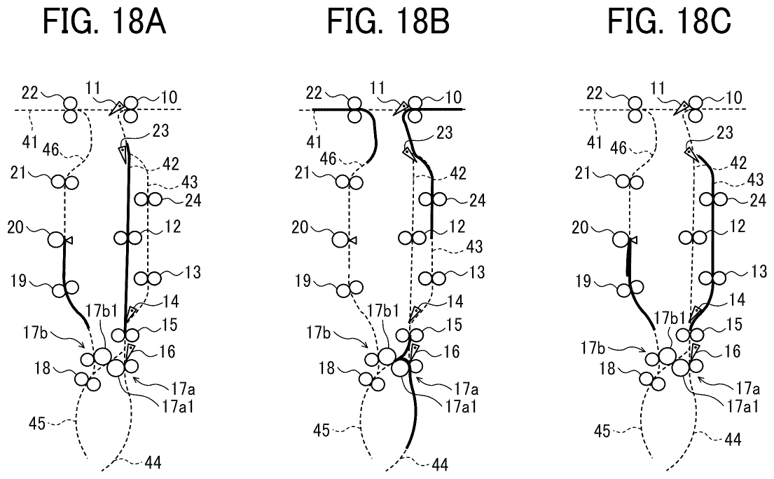

FIGS. 18A, 18B and 18C are diagrams illustrating an adjustment of time between sheets in the sheet folding apparatus 100 according to Modification 3.

The configuration illustrated in FIGS. 18A, 18B and 18C is a configuration in which the sheet folding apparatus 100 of the above-described embodiment further includes a fourth switching claw 23 to switch the direction of the sheet received in the second path 42 downstream from the first branching claw 11 in the sheet conveyance direction, to the third path 43. Further, a seventh conveyance roller pair 24 to convey a sheet is added on the third path 43, downstream from the fourth switching claw 23 in the sheet conveyance direction.

FIG. 18A illustrates a state in which the second sheet is received while the fold-enhancing operation is performed on the first sheet.

For example, when the number of times of the fold-enhancing operations on the first sheet is increased based on the predicted value of the height of fold obtained from the trained model 500, the stop time of the first sheet at the position of the fold-enhancing roller 20 increases. In this case, the sheet interval time between the first sheet and the second sheet is insufficient, the second sheet is temporarily stopped at a position before the start of the sheet folding operation on the second sheet, as illustrated in FIG. 18A, in order to obtain the insufficient time between the first sheet and the second sheet. With the leading end of the second sheet in contact with the registration roller pair 15, the conveyance of the second sheet is temporarily stopped to adjust the sheet interval. Subsequently, the leading end of the sheet is brought to contact the registration roller pair 15, the skew correction may be performed simultaneously while the sheet interval is adjusted.

Then, when the sheet interval time between the first sheet and the second sheet is obtained, as illustrated in FIG. 18B, the sheet folding operation on the second sheet is started. After the sheet folding operation on the second sheet is started, the sheet folding apparatus 100 receives the third sheet. At this time, the second conveyance roller pair 12 is likely to be driven to fold the second sheet. For this reason, the third sheet is retracted to the third path 43 by the fourth switching claw 23.

Then, after the sheet folding operation on the second sheet is completed and the registration roller pair 15 is stopped, the third sheet is brought into contact with the registration roller pair 15, and the sheet interval time between the second sheet and the third sheet is adjusted. At this time, the skew correction may be performed simultaneously while the sheet interval is adjusted.

When the sheet interval adjustment is to be performed on the subsequent sheet, the sheet interval time with the preceding sheet may be adjusted by alternately using the second path 42 and the third path 43 by using the fourth switching claw 23.

The sheet interval adjustment by the image forming apparatus 200 described in Modification 2 described above and the sheet interval adjustment by the sheet folding apparatus 100 described in Modification 3 may be combined. For example, the sheet folding apparatus 100 may perform the sheet interval adjustment until the sheet interval is provided by the image forming apparatus 200.

A description is given below of an example of another configuration of the fold-enhancing-type configuration of the sheet folding apparatus 100.

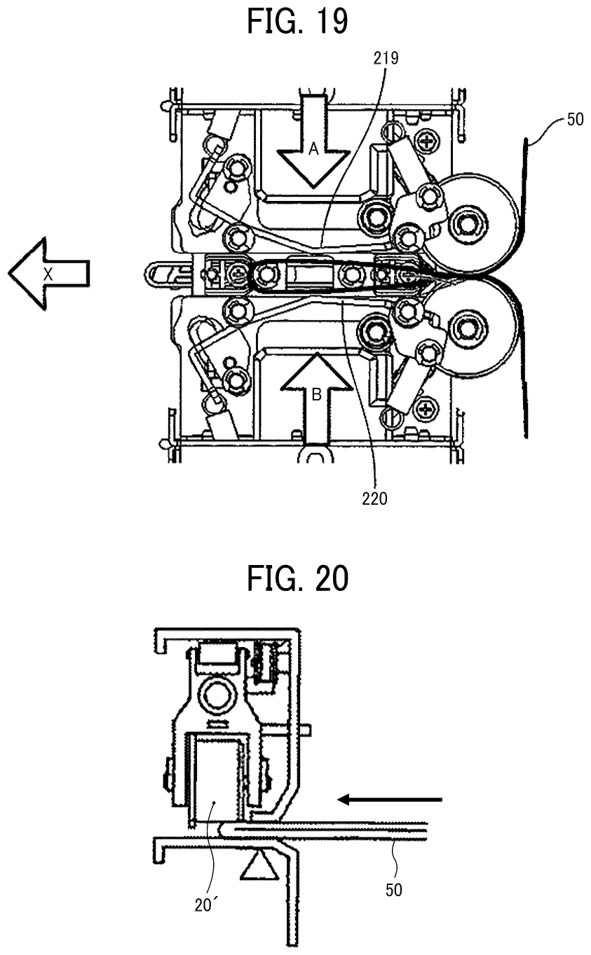

FIG. 19 is a diagram illustrating an example of a press-type configuration as another example of a fold-enhancing-type configuration of the sheet folding apparatus 100.

In the press-type configuration, the upper pressing plate 219 and the lower pressing plate 220 are operated to change the pressing region in the conveyance direction press area, so that the pressing time and the pressing force can be adjusted. In the press-type configuration, the control parameters including the pressing region, the pressing time, and the pressing force are changed according to the sheet size, the sheet thickness, and the number of times of multi-folding operations of overlapped sheets to be folded together. By so doing, the height of fold (folding evaluation value) can be adjusted.

In the press-type configuration, since a relatively large pressing force is applied over the entire area of the sheet, the driving load is relatively large. Thus, it is difficult to achieve energy saving. Accordingly, when the press-type configuration is adopted as the fold-enhancing-type configuration, it is preferable to provide an option such as the “energy-saving priority mode”.

FIG. 20 is a diagram illustrating an example of a roller-pressure-type configuration as yet another example of the fold-enhancing-type configuration of the sheet folding apparatus 100.

The roller-pressure-type configuration is a configuration in which the fold-enhancing operation is performed by moving a fold-enhancing roller 20′ in a direction orthogonal to the sheet conveyance direction. Since this configuration is to sequentially press the crease in the sheet along the direction of the fold, the energy efficiency is better when compared with the press-type configuration. Although the productivity is lower because the fold-enhancing roller 20′ is to be moved along the fold, the folding height (folding evaluation value) can be adjusted by changing the control parameter such as the size of the sheet 50, the thickness of the sheet 50, and the pressing force according to the number of sheets to be folded, as in the press-type configuration.

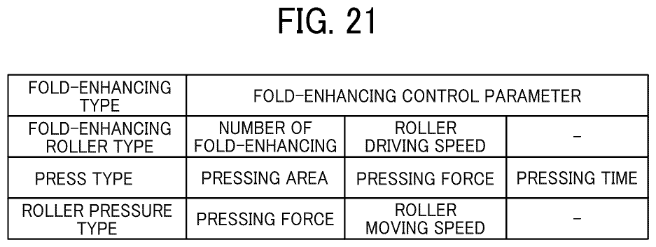

FIG. 21 is a table indicating kinds of a fold-enhancing-type configuration and a fold-enhancing control parameter adjustable by various configurations.

The fold-enhancing control parameter adjustable according to the predicted value of the folding height (folding evaluation value) from the trained model 500 depends on the kinds of fold-enhancing methods as illustrated in FIG. 21.

In the fold-enhancing-roller-type configuration including the fold-enhancing roller 20, according to the above-described embodiment, the number of rotations of the fold-enhancing roller 20 (the number of times of fold-enhancing operations) that is rotated when the crease of the fold of the sheet is reinforced (enhanced) and the roller driving speed of the fold-enhancing roller 20 are fold-enhancing control parameters that is adjustable and affect the height of fold of a sheet or sheets. In the fold-enhancing-roller-type configuration, for example, as the number of times of fold-enhancing operations is increased, the crease (folded portion) can be more enhanced, and the height of fold can be reduced. On the other hand, the stop time of the sheet is increased as the number of times of fold-enhancing operations is increased, and thus the productivity of the sheet folding operation is degraded.

In the press-type configuration as illustrated in FIG. 19, the pressing area and the pressing force and pressing time when the crease (folded portion) is pressed are the fold-enhancing control parameters that is adjustable and affect the height of fold. In the press-type configuration, when the line of the crease (folded portion) is to be reinforced (enhanced), the pressing force or the pressing time may be increased.

In addition, when the number of times of multi-folding operations of overlapped sheets to be folded together is relatively large, the width of the crease (folded portion) is increased by the number of sheets. As a result, the crease (folded portion) be easily reinforced (enhanced) by increasing the pressing area. On the other hand, when the pressing force is increased, the load on the motor increases. As a result, the power consumption increases, and the energy-saving performance is lowered. As the pressing time becomes longer, the power consumption increases, and the energy-saving performance is lowered. Furthermore, the sheet stop time becomes longer, so that the productivity of the sheet folding operation is also degraded. Further, when the pressing area increases, the pressing force when the crease (folded portion) is pressed is dispersed. As a result, the pressing force needs to be compensated, and the energy-saving property and the productivity of the sheet folding operation are degraded.

In the roller-pressure-type configuration as illustrated in FIG. 20, the pressing force of the roller used for enhancing the crease (folded portion) and the roller moving speed at which the roller is moved are the fold-enhancing control parameters that is adjustable and affect the height of fold. When the crease (folded portion) is to be reinforced (enhanced) with the roller-pressure-type configuration, the pressing force of the roller may be increased or the roller moving speed may be decreased to extend the pressing time. On the other hand, as in the press-type configuration, when the pressing force is increased, the power consumption is increased and the energy saving property is lowered. As a result, when the roller moving speed is decreased, the productivity of the sheet folding operation is degraded.

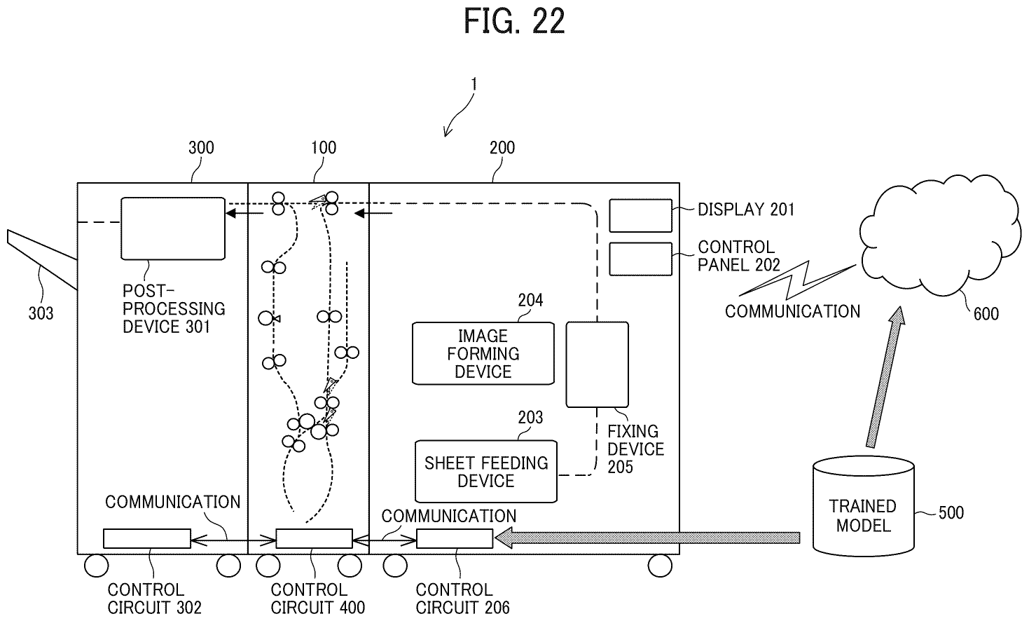

In the above description, the trained model 500 is implemented in the control circuit 400 of the sheet folding apparatus 100, and the estimation program (a part of the control program) is written in the control circuit 400 of the sheet folding apparatus 100. The trained model 500 is a computer program, and thus may be held in a device other than the sheet folding apparatus 100. For example, as illustrated in FIG. 22, the trained model 500 may be implemented in the control circuit 206 included by the image forming apparatus 200 with which the sheet folding apparatus 100 can communicate. In this case, since the image forming apparatus 200 has a function of setting sheet information and folding information, the height of fold (folding evaluation value) can be estimated in the image forming apparatus 200 based on the information.

The trained model 500 may be held in a cloud system 600 with which, for example, the image forming apparatus 200 communicates via a network. In this case, sheet information and folding information for estimating the height of fold (folding evaluation value) are transmitted to the cloud system 600, and the image forming apparatus 200 receives the result estimated by the trained model on the cloud system 600, so that the sheet folding operation can be controlled according to the height of fold estimated by the trained model.

The trained model 500 may be stored on a cloud system 600, and, at the timing at which the power of the image forming apparatus 200 is turned on, the trained model 500 on the cloud system 600 can be downloaded. With this method, no communication needs to be done between the image forming apparatus 200 and the cloud system 600 during a print job, and the period of time from the print job instruction by the user to the start of the print job can be reduced.

The configurations according to the above-descried embodiments are examples, and embodiments of the present disclosure are not limited to the above. For example, the following aspects can achieve effects described below.

### First Aspect

In a first aspect, a sheet folding apparatus (for example, the sheet folding apparatus 100) includes a sheet folder (for example, the first folding roller pair 17a, the second folding roller pair 17b, the fold-enhancing roller 20) and circuitry (for example, the control circuit 400). The sheet folder includes a sheet folding portion (for example, the first folding roller pair 17a, the second folding roller pair 17b) for folding a processing target sheet (for example, the sheet (the processing target sheet) 50), and a fold-enhancing portion (for example, the fold-enhancing roller 20) to enhance a crease (folded portion) in the processing target sheet formed by the sheet folding portion. The circuitry is to control a folding operation of the sheet folder. The sheet folding apparatus according to the first aspect further includes an information acquirer (for example, the communication interface 409), an estimation unit (for example, the control circuit 400), and a determiner (for example, the control circuit 400). The information acquirer acquires sheet information of the processing target sheet on which the folding operation of the sheet folder is performed, and folding information indicating a content of the folding operation of the sheet folder on the processing target sheet, before completion of the folding operation of the sheet folder. The estimation unit runs, by a computer (for example, the CPU 410), a trained model (for example, the trained model 500) obtained by sheet information of a sheet for training, folding information indicating a content of the folding operation on the sheet for training, and multiple training datasets including a folding evaluation value after the folding operation on the sheet for training, and estimates the folding evaluation value after the folding operation on the processing target sheet, based on the sheet information of the processing target sheet and the folding information indicating the content of the folding operation of the sheet folder on the processing target sheet, acquired by the information acquirer. The determiner determines a control content in the folding operation on the processing target sheet, based on the folding evaluation value.

In order to enhance the folding quality of the sheet in the sheet folding apparatus, it is required to appropriately select and execute the sheet folding contents (for example, pressing force and pressure time in the sheet folding portion or the fold-enhancing portion, the folding kinds in the sheet folding portion, the number of times of fold-enhancing operations in the fold-enhancing portion) according to various conditions. For example, differences in sheet kinds such as sheet size, thickness, stiffness, glossiness, and smoothness affect the result of the sheet folding operation (for example, the folding quality). For this reason, such differences are highly desired conditions for an appropriate selection of the sheet folding contents. Further, since a difference in the sheet folding contents such as the folding kind, the number of times of multi-folding operations of overlapped sheets to be folded together, the number of times of the fold-enhancing operations, a fold-enhancing stop position also affects the result of the sheet folding operation, such a difference is a highly desired condition for an appropriate selection of the sheet folding contents.

Typically, there are various conditions for an appropriate selection of the sheet folding contents for each use state of the user. For this reason, the number of combinations of the conditions is enormous. In addition, there are, for example, users who use a special kind of sheet that is not distributed in the market, users who use a special folding kind, and users who have a special setting of a target height of fold of a sheet or sheets. For the above-described reasons, it is practically difficult to grasp appropriate sheet folding contents by performing, for example, a test in advance for all combinations. As a result, it was difficult to appropriately select and execute the sheet folding contents under the various usage conditions of each user. If the sheet folding contents may not be appropriately selected, for example, the fold-enhancing operation is insufficient, the folding height may not be sufficiently reduced due to the insufficient fold-enhancing operation, and the folding quality may not be obtained in some cases. Further, for example, excessive fold-enhancing may cause a deterioration in productivity and wasteful consumption of electric power.

In the first aspect, the sheet information of the processing target sheet to folded and the folding information indicating the sheet folding contents are acquired before completion of the sheet folding operation. Based on the above-described information, the folding evaluation value after the sheet folding operation on the processing target sheet is estimated in advance. Then, based on the folding evaluation value estimated in advance, the control contents of the controller for the sheet folding operation on the processing target sheet is determined, and the sheet folder is controlled to perform the sheet folding operation on the processing target sheet with the determined control contents. According to the first aspect, a folding evaluation value related to the evaluation result of the folding quality of the sheet folding operation on the processing target sheet is estimated in advance. Accordingly, the contents of the sheet folding operation on the processing target sheet can be adequately adjusted according to the folding evaluation value.

In addition, the pre-estimation of the folding evaluation value in the first aspect uses the trained model obtained by using multiple training datasets including the sheet information of the sheet for training, the folding information of the sheet for training, and the folding evaluation value after the sheet folding operation on the sheet for training. In order to obtain the trained model, the sheet folding operation is performed in advance using various sheets for training with various sheet folding contents, and the quality of each sheet folding is evaluated to obtain the folding evaluation value. Then, for example, machine learning is performed using training datasets including multiple training datasets including the sheet information, the folding information, and the folding evaluation value of each sheet. By so doing, the trained model is obtained. According to the trained model obtained as described above, even if the sheet kinds or the sheet folding contents do not match the sheet information and the folding information used as training datasets when the sheet folding operation on a processing target sheet is actually performed, the folding evaluation value indicating the folding quality after the sheet folding operation can be estimated with high accuracy. Accordingly, even if the conditions (e.g., sheet type, sheet folding contents) for selecting the appropriate sheet folding contents are various for each user's usage, the folding quality after the sheet folding operation under the under the various usage conditions of each user can be grasped in advance, and the sheet folding contents can be appropriately adjusted. Accordingly, the sheet processing apparatus according to the first aspect can appropriately select the sheet folding contents and execute an appropriate sheet folding operation under the various usage conditions of each user.

### Second Aspect

In a second aspect, in the sheet folding apparatus according to the first aspect, the information acquirer acquires a driving state information (for example, the drive current value of the sheet folder motor 412) indicating a driving state of the sheet folder during the folding operation, before completion of the sheet folding operation. The trained model is obtained using the multiple training datasets including the driving state information of the sheet folder during the sheet folding operation on the sheet for training. The estimation unit estimates the folding evaluation value based on the multiple training datasets including the acquired driving state information by running the trained model by computer.

According to the present aspect, due to the trained model that obtained by using the training datasets including the driving state information of the sheet folder, the folding evaluation value can be estimated with higher accuracy.

### Third Aspect

In a third aspect, in the sheet folding apparatus according to the first aspect or the second aspect, the folding information includes at least one of the folding pattern, the number of times of multi-folding operations of overlapped sheets to be folded together, the number of times of the fold-enhancing operations, or the fold-enhancing stop position.

According to the present aspect, due to the trained model that obtained by using the training datasets including the information of the folding pattern, the number of times of multi-folding operations of overlapped sheets to be folded together, the number of times of the fold-enhancing operations, or the fold-enhancing stop position, which affect the result of the sheet folding operation (for example, the folding quality), the folding evaluation value can be estimated with high accuracy.

### Fourth Aspect

In a first aspect, a sheet folding apparatus (for example, the sheet folding apparatus 100) includes a sheet folder (for example, the first folding roller pair 17a, the second folding roller pair 17b, the fold-enhancing roller 20) and a control unit (for example, the control circuit 400). The sheet folder includes a sheet folding portion (for example, the first folding roller pair 17a, the second folding roller pair 17b) to fold a processing target sheet (for example, the sheet (the processing target sheet) 50), and a fold-enhancing portion (for example, the fold-enhancing roller 20) to enhance a crease (folded portion) in the processing target sheet formed by the sheet folding portion. The control unit is to control a folding operation performed by the sheet folder. The sheet folding apparatus according to the fourth aspect further includes an information acquirer (for example, the communication interface 409, the current reading controller 413), an estimation unit (for example, the control circuit 400), and a determiner (for example, the control circuit 400). The information acquirer acquires sheet information of the processing target sheet on which the folding operation of the sheet folder is performed, and driving state information (for example, the drive current value of the sheet folder motor 412) indicating a driving state of the sheet folder during the folding operation on the processing target sheet, before completion of the folding operation of the sheet folder. The estimation unit runs, by a computer (for example, the CPU 410), a trained model (for example, the trained model 500) obtained by multiple training datasets including the sheet information of a sheet for training, the driving state information of the sheet folder during the sheet folding operation on the sheet for training, and a folding evaluation value (for example, the height of fold) after the sheet folding operation on the sheet for training, and estimates the folding evaluation value after the sheet folding operation on the processing target sheet, based on the sheet information and the driving state information acquired by the information acquirer. The determiner determines a control content of the control unit in the sheet folding operation on the processing target sheet.

In the present aspect, the sheet information of the processing target sheet on which the sheet folding operation is performed and the driving state information indicating the driving state of the sheet folder during the sheet folding operation are acquired before completion of the sheet folding operation, and the folding evaluation value after the sheet folding operation on the processing target sheet is estimated based on the sheet information and the driving state information in advance. Then, based on the folding evaluation value estimated in advance, the control contents of the controller for the sheet folding operation on the processing target sheet is determined, and the sheet folder is controlled to perform the sheet folding operation on the processing target sheet with the determined control contents. According to the fourth aspect, a folding evaluation value related to the evaluation result of the folding quality of the sheet folding operation on the processing target sheet is estimated in advance. Accordingly, the contents of the sheet folding operation on the processing target sheet can be adequately adjusted according to the folding evaluation value.

Furthermore, the pre-estimation of the folding evaluation value in the fourth aspect uses the trained model obtained by using multiple training datasets including the sheet information of the sheet for training, the driving state information of the sheet folder during the sheet folding operation on the sheet for training, and the folding evaluation value after the sheet folding operation on the sheet for training. In order to obtain the trained model, the sheet folding operation is performed in advance using various sheets for training with various sheet folding contents, so that the driving state information of the sheet folder is obtained, and the quality of each sheet folding is evaluated to obtain the folding evaluation value.

Then, for example, machine learning is performed using training datasets including multiple training datasets including the sheet information, the driving state information, and the folding evaluation value of each sheet. By so doing, the trained model is obtained. According to the trained model obtained as described above, even if the sheet kinds or the driving state information do not match the sheet information and the driving state information used as training datasets when the sheet folding operation on a processing target sheet is actually performed, the folding evaluation value indicating the folding quality after the sheet folding operation can be estimated with high accuracy. Accordingly, even if the conditions (e.g., sheet type, driving state information) for selecting the appropriate sheet folding contents are various for each user's usage, the folding quality after the sheet folding operation under the various usage conditions of each user can be grasped in advance, and the sheet folding contents can be appropriately adjusted. Accordingly, the sheet processing apparatus according to the first aspect can appropriately select the sheet folding contents and execute an appropriate sheet folding operation under the various usage conditions of each user.

### Fifth Aspect

In a fifth aspect, in the sheet folding apparatus according to any one of the first aspect to the fourth aspect, the folding evaluation value includes a height of fold of the processing target sheet after the sheet folding operation.

Since the height of fold of the processing target sheet after the sheet folding operation is a direct index value to evaluate the result of the sheet folding operation, the sheet folding contents can be appropriately adjusted.

### Sixth Aspect

In a sixth aspect, in the sheet folding apparatus according to any one of the first aspect to the fifth aspect, the control contents to be determined by the determiner include at least one of the sheet pressing force, the sheet pressure time, or the number of times of the fold-enhancing operations of the fold-enhancing portion in the sheet folding operation. Since the sheet pressing force, the sheet pressure time, or the number of times of the fold-enhancing operations of the fold-enhancing portion in the sheet folding operation are valid control parameters for improving the result of the sheet folding operation, the sheet folding contents can be improved appropriately.

### Seventh Aspect

In a seventh aspect, the sheet folding apparatus according to any one of the first aspect to the sixth aspect further includes a sheet receiver (for example, the first conveyance roller pair 10) and a notification unit (for example, the communication interface 409). The sheet receiver receives an image-formed sheet on which an image is formed by an image forming apparatus (for example, the image forming apparatus 200) as the processing target sheet. The notification unit notifies the image forming apparatus of the sheet receiving interval of the sheet receiver, according to the control contents determined by the determiner. According to the present aspect, when the sheet interval needs to be adjusted according to the control contents determined by the determiner, the notification unit notifies the image forming apparatus of the sheet receiving interval according to the control contents determined by the determiner, and the image forming apparatus can control the adjustment of the sheet receiving interval.

### Eighth Aspect

In an eighth aspect, the sheet folding apparatus according to any one of the first aspect to the seventh aspect further includes a sheet receiver (for example, the first conveyance roller pair 10) and a sheet interval adjuster (for example, the control circuit 400). The sheet receiver receives an image-formed sheet as the processing target sheet. The sheet interval adjuster adjusts a sheet interval of processing target sheets received by the sheet receiver, according to the control contents determined by the determiner.

According to the present aspect, when the sheet interval needs to be adjusted according to the control contents determined by the determiner, the sheet interval can be adjusted in the sheet folding apparatus.

### Ninth Aspect

In a ninth aspect, in the sheet folding apparatus according to any one of the first aspect to the eighth aspect, the sheet information is input by a user.

This configuration in which the sheet information is input by a user can reduce or eliminate the number of sensors for detecting the sheet information, the configuration can be simplified.

### Tenth Aspect

In a tenth aspect, in the sheet folding apparatus according to any one of the first aspect to the eighth aspect, the sheet information is sheet information that can be obtained from the result of detection by the sheet information detector.

The sheet information detected by the detection (sensing) by the sheet information detector can estimate the folding evaluation value with higher accuracy and higher precision compared to the sheet information obtained through an input by the user.

### Eleventh Aspect

In an eleventh aspect, in the sheet folding apparatus according to the tenth aspect, the sheet information detector detects sheet information including at least one of the size, thickness, stiffness, glossiness, or smoothness of a sheet.

Due to the trained model that obtained by using the training datasets including the size, thickness, stiffness, glossiness, or smoothness of a sheet that can affect the result of the sheet folding operation (for example, the folding quality), the folding evaluation value can be estimated with high accuracy.

### Twelfth Aspect

In a twelfth aspect, in the sheet folding apparatus according to any one of the first aspect to the eleventh aspect, the information acquirer acquires environmental information including at least one of temperature or humidity detected by an environmental information detector (for example, the temperature sensor 415), before completion of the sheet folding operation. The trained model is obtained using the multiple training datasets including the environmental information detected by the environmental information detector when the sheet folding operation is performed on the sheet for training. The estimation unit estimates the folding evaluation value based on the multiple training datasets including the environmental information acquired by the information acquirer as well as the sheet information of the processing target sheet and the folding information also acquired by the information acquirer.

Due to the trained model that obtained by using the training datasets including the environmental information that affects the result of the sheet folding operation (for example, the folding quality), the folding evaluation value can be estimated with high accuracy.

### Thirteenth Aspect

In a thirteenth aspect, in the sheet folding apparatus according to any one of the first aspect to the twelfth aspect, the determiner includes a determination condition changer (for example, the control circuit 400) to change a determination condition (for example, the enhancement reference value H_{S} and the relaxation reference value H_{W} of the height of fold) to determine the control contents.

This configuration can achieve customization of the control contents to be determined, according to a user's request.

### Fourteenth Aspect

In a fourteenth aspect, in the sheet folding apparatus according to the thirteenth aspect, the determination condition that is changed by the determination condition changer includes at least one condition of a condition that changes the stacking height indicating the height that the processing target sheets subjected to the sheet folding operation are stacked (for example, the enhancement reference value H_{S} and the relaxation reference value H_{W}), a condition that changes the number of process completed sheets in the sheet folding operation per unit time (for example, the enhancement reference value H_{S} and the relaxation reference value H_{W}), and a condition that changes the power consumption amount for the sheet folding operation (for example, the enhancement reference value H_{S} and the relaxation reference value H_{W}).

This configuration can achieve customization according to a user's request, such as giving priority to an increase in the number of stacked sheets, giving priority to the productivity, or giving priority to energy saving.

### Fifteenth Aspect

In a fifteenth aspect, an image forming apparatus includes the sheet folding apparatus according to any one of the first aspect to the fourteenth aspect.

According to the fifteenth aspect, the image forming apparatus can be provided with the sheet folding apparatus that can appropriately select the sheet folding contents and execute an appropriate sheet folding operation under various usage conditions of each user.

### Sixteenth Aspect

In a sixteenth aspect, an image forming system (for example, the image forming system 1) includes an image forming apparatus (for example, the image forming apparatus 200) and a sheet folding apparatus (for example, the sheet folding apparatus 100) to perform a folding operation on an image-formed sheet, as a processing target sheet, on which an image is formed by the image forming apparatus. The sheet folding apparatus includes the sheet folding apparatus according to any one of the first aspect to the fourteenth aspect. According to the sixteenth aspect, the image forming system can be provided with the sheet folding apparatus that can appropriately select the sheet folding contents and execute an appropriate sheet folding operation under various usage conditions of each user.

### Seventeenth Aspect

In a seventeenth aspect, the image forming apparatus according to the sixteenth aspect includes at least one of the information acquirer, the estimation unit, or the determiner is provided in the image forming apparatus.

According to this configuration, the information acquirer, the estimation unit, and the determiner can be operated by using the function provided in the image forming apparatus.

### Eighteenth Aspect

In an eighteenth aspect, a sheet folding apparatus (for example, the sheet folding apparatus 100) includes a sheet folding folder (for example, the first folding roller pair 17a, the second folding roller pair 17b, the fold-enhancing roller 20) and circuitry (for example, the control circuit 400). The sheet folder includes a sheet folding part (for example, the first folding roller pair 17a, the second folding roller pair 17b) to fold a sheet to form a folding portion in the sheet, and an additional folding part (for example, the fold-enhancing roller 20) to apply additional pressure to the folding portion in the sheet folded by the sheet folding part to reinforce the folding portion. The circuitry is to control the sheet folder to form the folding portion and reinforce the folding portion in the sheet, as a folding operation; acquire, before completion of the folding operation, first sheet information of the sheet to which the sheet folder performs the folding operation, and first folding information indicating a type of the folding operation to be performed on the sheet by the sheet folder; run a trained model obtained through machine learning executed using second sheet information of a training sheet, second folding information indicating a type of the folding operation performed on the training sheet, and multiple training datasets including a folding evaluation value obtained by performing the folding operation on the training sheet; estimate the folding evaluation value after the completion of the folding operation on the sheet, based on the first sheet information and the first folding information; and determine the type of a control content in the folding operation to be performed by the sheet folder on the sheet, based on the folding evaluation value.

### Nineteenth Aspect

In a nineteenth aspect, in the sheet folding apparatus according to the eighteenth aspect, the circuitry is further to acquire a driving state information indicating a driving state of the sheet folder during the folding operation before the completion of the folding operation, and obtain the trained model using the multiple training datasets including the driving state information of the sheet folder during the folding operation on the training sheet. The circuitry is further to run the trained model, and estimate the folding evaluation value based on the multiple training datasets including the driving state information.

### Twentieth Aspect

In a twentieth aspect, in the sheet folding apparatus according to the eighteenth aspect or the nineteenth aspect, the second folding information includes at least one of the type of the folding operation, a number of sheets including the sheet to be overlayed and folded, a number of times the additional folding part reinforces the folding portion in the sheet, or a stop position of the sheet relative to the additional folding part.

### Twenty-First Aspect

In a twenty-first aspect, in the sheet folding apparatus according to any one of the eighteenth aspect to the twentieth aspect, the folding evaluation value includes a height of the folding portion in the sheet after the completion of the folding operation.

### Twenty-Second Aspect

In a twenty-second aspect, in the sheet folding apparatus according to any one of the eighteenth aspect to the twenty-first aspect, the circuitry is to determine the control content including at least one of a sheet pressing force applied to the sheet by the additional folding part, a sheet pressing period of the additional folding part, or a number of times the additional folding part reinforces the folding portion in the sheet.

### Twenty-Third Aspect

In a twenty-third aspect, the sheet folding apparatus according to any one of the eighteenth aspect to the twenty-second aspect further includes a sheet receiver (for example, the first conveyance roller pair 10) to receive sheets including the sheet on which an image is formed by an image forming apparatus at a predetermined interval, and a notifier (for example, the communication interface 409) to notify the image forming apparatus of the predetermined interval of the sheet receiver according to the type of the folding operation.

### Twenty-Fourth Aspect

In a twenty-fourth aspect, the sheet folding apparatus according to any one of the eighteenth aspect to the twenty-third aspect further includes a sheet receiver (for example, the first conveyance roller pair 10) to receive sheets including the sheet on which an image is formed by an image forming apparatus at a predetermined interval. The circuitry is further to adjust the predetermined interval of the sheets received by the sheet receiver, according to the type of the folding operation.

### Twenty-Fifth Aspect

In a twenty-fifth aspect, the sheet folding apparatus according to any one of the eighteenth aspect to the twenty-fourth aspect further includes an environmental information detector (for example, the temperature sensor 415) to detect a temperature and a humidity. The circuitry is further to acquire an environmental information including at least one of the temperature or the humidity before the completion of the folding operation, and obtain the trained model using the multiple training datasets including the environmental information of the sheet folder during the folding operation on the training sheet. The circuitry is further to run the trained model, and estimate the folding evaluation value based on the multiple training datasets including the environmental information.

### Twenty-Sixth Aspect

In a twenty-sixth aspect, in the sheet folding apparatus according to any one of the eighteenth aspect to the twenty-fifth aspect, the circuitry is further to change a determination condition to determine the control content.

### Twenty-Seventh Aspect

In a twenty-seventh aspect, an image forming apparatus includes the sheet folding apparatus according to any one of the eighteenth aspect to the twenty-sixth aspect.

### Twenty-Eighth Aspect

In a twenty-eighth aspect, an image forming system includes an image forming apparatus to form an image on a sheet, and the sheet folding apparatus according to any one of the eighteenth aspect to the twenty-sixth aspect to perform the folding operation on the sheet, on which the image is formed by the image forming apparatus.

### Twenty-Ninth Aspect

In a twenty-ninth aspect, a sheet folding apparatus (for example, the sheet folding apparatus 100) includes a sheet folding folder (for example, the first folding roller pair 17a, the second folding roller pair 17b, the fold-enhancing roller 20) and circuitry (for example, the control circuit 400). The sheet folder includes a sheet folding part (for example, the first folding roller pair 17a, the second folding roller pair 17b) to fold a sheet to form a folding portion in the sheet, and an additional folding part (for example, the fold-enhancing roller 20) to apply additional pressure to the folding portion in the sheet folded by the sheet folding part to reinforce the folding portion. The circuitry is to control the sheet folder to form the folding portion and reinforce the folding portion in the sheet, as a folding operation; acquire, before completion of the folding operation, first sheet information of the sheet on which the sheet folder performs the folding operation, first driving state information of a driving state of the sheet folder during the folding operation; run a trained model obtained through machine learning executed using second sheet information of a training sheet, second driving state information of a driving state of the sheet folder during the folding operation on the training sheet, and multiple training datasets including a folding evaluation value after the folding operation on the training sheet; estimate the folding evaluation value after the folding operation on the sheet, based on the first sheet information and the first driving state information; and determine the type of a control content in the folding operation to be performed by the sheet folder on the sheet, based on the folding evaluation value.

### Thirtieth Aspect

In a thirtieth aspect, in the sheet folding apparatus according to the twenty-ninth aspect, the folding evaluation value includes a height of the folding portion in the sheet after the completion of the folding operation.

### Thirty-First Aspect

In a thirty-first aspect, in the sheet folding apparatus according to any one of the twenty-ninth aspect to the thirtieth aspect, the circuitry is to determine the control content including at least one of a sheet pressing force applied to the sheet by the additional folding part, a sheet pressing period of the additional folding part, or a number of times the additional folding part reinforces the folding portion in the sheet.

### Thirty-Second Aspect

In a thirty-second aspect, the sheet folding apparatus according to any one of the twenty-ninth aspect to the thirty-first aspect further includes a sheet receiver (for example, the first conveyance roller pair 10) to receive sheets including the sheet on which an image is formed by an image forming apparatus at a predetermined interval, and a notifier (for example, the communication interface 409) to notify the image forming apparatus of the predetermined interval of the sheet receiver according to the type of the folding operation.

### Thirty-Third Aspect

In a thirty-third aspect, the sheet folding apparatus according to any one of the twenty-ninth aspect to the thirty-second aspect further includes a sheet receiver (for example, the first conveyance roller pair 10) to receive sheets including the sheet on which an image is formed by an image forming apparatus at a predetermined interval. The circuitry is further to adjust the predetermined interval of the sheets received by the sheet receiver, according to the type of the folding operation.

### Thirty-Fourth Aspect

In a thirty-fourth aspect, the sheet folding apparatus according to any one of the twenty-ninth aspect to the thirty-third aspect further includes an environmental information detector (for example, the temperature sensor 415) to detect a temperature and a humidity. The circuitry is further to acquire an environmental information including at least one of the temperature or the humidity before the completion of the folding operation, and obtain the trained model using the multiple training datasets including the environmental information of the sheet folder during the folding operation on the training sheet. The circuitry is further to run the trained model, and estimate the folding evaluation value based on the multiple training datasets including the environmental information.

### Thirty-Fifth Aspect

In a thirty-fifth aspect, in the sheet folding apparatus according to any one of the twenty-ninth aspect to the thirty-fourth aspect, the circuitry is further to change a determination condition to determine the control content.

### Thirty-Sixth Aspect

In a thirty-sixth aspect, an image forming apparatus includes the sheet folding apparatus according to any one of the twenty-ninth aspect to the thirty-fifth aspect.

### Thirty-Seventh Aspect

In a thirty-seventh aspect, an image forming system includes an image forming apparatus to form an image on a sheet, and the sheet folding apparatus according to any one of the twenty-ninth aspect to the thirty-fifth aspect to perform the folding operation on the sheet, on which the image is formed by the image forming apparatus.

The present disclosure is not limited to specific embodiments described above, and numerous additional modifications and variations are possible in light of the teachings within the technical scope of the appended claims. It is therefore to be understood that the disclosure of this patent specification may be practiced otherwise by those skilled in the art than as specifically described herein, and such, modifications, alternatives are within the technical scope of the appended claims. Such modifications are also included in the technical scope of the present disclosure.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A sheet folding apparatus comprising:
a sheet folder including:
a sheet folding part to fold a sheet to form a folding portion in the sheet; and
an additional folding part to apply additional pressure to the folding portion in the sheet folded by the sheet folding part to reinforce the folding portion; and
circuitry configured to:
control the sheet folder to form the folding portion and reinforce the folding portion in the sheet, as a folding operation;
acquire, before completion of the folding operation,
first sheet information of the sheet to which the sheet folder performs the folding operation; and
first folding information indicating a type of the folding operation to be performed on the sheet by the sheet folder;
run a trained model obtained through machine learning executed using:
second sheet information of a training sheet;
second folding information indicating a type of the folding operation performed on the training sheet; and
multiple training datasets including a folding evaluation value obtained by performing the folding operation on the training sheet;
estimate the folding evaluation value after the completion of the folding operation on the sheet, based on the first sheet information and the first folding information; and
determine the type of a control content in the folding operation to be performed by the sheet folder on the sheet, based on the folding evaluation value.

2. The sheet folding apparatus according to claim 1,
wherein the circuitry is further configured to:
acquire a driving state information indicating a driving state of the sheet folder during the folding operation before the completion of the folding operation; and
obtain the trained model using the multiple training datasets including the driving state information of the sheet folder during the folding operation on the training sheet, and
the circuitry is further configured to:
run the trained model; and
estimate the folding evaluation value based on the multiple training datasets including the driving state information.

3. The sheet folding apparatus according to claim 1,
wherein the second folding information includes at least one of:
the type of the folding operation;
a number of sheets including the sheet to be overlayed and folded;
a number of times the additional folding part reinforces the folding portion in the sheet; or
a stop position of the sheet relative to the additional folding part.

4. The sheet folding apparatus according to claim 1,
wherein the folding evaluation value includes a height of the folding portion in the sheet after the completion of the folding operation.

5. The sheet folding apparatus according to claim 1,
wherein the circuitry determines the control content including at least one of:
a sheet pressing force applied to the sheet by the additional folding part;
a sheet pressing period of the additional folding part; or
a number of times the additional folding part reinforces the folding portion in the sheet.

6. The sheet folding apparatus according to claim 1, further comprising:
a sheet receiver to receive sheets including the sheet on which an image is formed by an image forming apparatus at a predetermined interval; and
a notifier to notify the image forming apparatus of the predetermined interval of the sheet receiver according to the type of the folding operation.

7. The sheet folding apparatus according to claim 1, further comprising a sheet receiver to receive sheets including the sheet on which an image is formed by an image forming apparatus at a predetermined interval,
wherein the circuitry is further configured to adjust the predetermined interval of the sheets received by the sheet receiver, according to the type of the folding operation.

8. The sheet folding apparatus according to claim 1, further comprising an environmental information detector to detect at least one of a temperature or a humidity,
wherein the circuitry is further configured to:
acquire an environmental information including at least one of the temperature or the humidity before the completion of the folding operation; and
obtain the trained model using the multiple training datasets including the environmental information of the sheet folder during the folding operation on the training sheet, and
the circuitry is further configured to:
run the trained model; and
estimate the folding evaluation value based on the multiple training datasets including the environmental information.

9. The sheet folding apparatus according to claim 1,
wherein the circuitry is further configured to change a determination condition to determine the control content.

10. An image forming apparatus comprising the sheet folding apparatus according to claim 1.

11. An image forming system comprising:
an image forming apparatus to form an image on a sheet; and
the sheet folding apparatus according to claim 1 to perform the folding operation on the sheet, on which the image is formed by the image forming apparatus.

12. A sheet folding apparatus comprising:
a sheet folder including:
a sheet folding part to fold a sheet to form a folding portion in the sheet; and
an additional folding part to apply additional pressure to the folding portion in the sheet formed by the sheet folding part to reinforce the folding portion; and
circuitry configured to:
control the sheet folder to form the folding portion and reinforce the folding portion in the sheet, as a folding operation;
acquire, before completion of the folding operation,
first sheet information of the sheet on which the sheet folder performs the folding operation; and
first driving state information of a driving state of the sheet folder during the folding operation;
run a trained model obtained through machine learning executed using:
second sheet information of a training sheet;
second driving state information of a driving state of the sheet folder during the folding operation on the training sheet; and
multiple training datasets including a folding evaluation value after the folding operation on the training sheet;
estimate the folding evaluation value after the folding operation on the sheet, based on the first sheet information and the first driving state information; and
determine the type of a control content in the folding operation to be performed by the sheet folder on the sheet, based on the folding evaluation value.

13. The sheet folding apparatus according to claim 12,
wherein the folding evaluation value includes a height of the folding portion in the sheet after the completion of the folding operation.

14. The sheet folding apparatus according to claim 12,
wherein the circuitry determines the control content including at least one of:
a sheet pressing force applied to the sheet by the additional folding part;
a sheet pressing period of the additional folding part; or
a number of times the additional folding part reinforces the folding portion in the sheet.

15. The sheet folding apparatus according to claim 12, further comprising:
a sheet receiver to receive sheets including the sheet on which an image is formed by an image forming apparatus at a predetermined interval; and
a notifier to notify the image forming apparatus of the predetermined interval of the sheet receiver according to the type of the folding operation.

16. The sheet folding apparatus according to claim 12, further comprising a sheet receiver to receive sheets including the sheet on which an image is formed by an image forming apparatus at a predetermined interval,
wherein the circuitry is further configured to adjust the predetermined interval of the sheets received by the sheet receiver, according to the type of the folding operation.

17. The sheet folding apparatus according to claim 12, further comprising an environmental information detector to detect at least one of a temperature or a humidity,
wherein the circuitry is further configured to:
acquire an environmental information including at least one of the temperature or the humidity before the completion of the folding operation; and
obtain the trained model using the multiple training datasets including the environmental information of the sheet folder during the folding operation on the training sheet, and
the circuitry is further configured to:
run the trained model; and
estimate the folding evaluation value based on the multiple training datasets including the environmental information.

18. The sheet folding apparatus according to claim 12,
wherein the circuitry is further configured to change a determination condition to determine the control content.

19. An image forming apparatus comprising the sheet folding apparatus according to claim 12.

20. An image forming system comprising:
an image forming apparatus to form an image on a sheet; and
the sheet folding apparatus according to claim 12 to perform the folding operation on the sheet, on which the image is formed by the image forming apparatus, as the sheet.
